(19) United States
(12) Patent Application Publication
(10) Pub. No.: US 2012/0212599 A1
(43) Pub. Date: Aug. 23, 2012

(54) IMAGING APPARATUS AND IMAGING METHOD

(75) Inventor: Tomochika Murakami, Ichikawa-shi (JP)

(73) Assignee: CANNON KABUSHIKI KAISHA, Tokyo (JP)

(21) Appl. No.: 13/359,987

(22) Filed: Jan. 27, 2012

(30) Foreign Application Priority Data
Feb. 18, 2011 (JP) 2011-033116

(51) Int. Cl. H04N 7/18

(52) U.S. Cl. 348/79; 348/E07.085

(57) ABSTRACT

An imaging method includes: a preliminary measurement step of imaging an object on a stage with an imaging unit; a determination step of determining the number of images to be captured of the object by analyzing the image data obtained in the preliminary measurement step; and a main measurement step of performing, according to the number of images to be captured determined in the determination step, either first processing for acquiring image data of a single image by imaging the object on the stage, or second processing for acquiring image data of a plurality of images with different focal positions by imaging the object on the stage for a plurality of times while changing the focal position.

### BACKGROUND OF THE INVENTION

1. Field of the Invention

This invention relates to an imaging apparatus and an imaging method, and in particular to an imaging apparatus and an imaging method for obtaining a plurality of two-dimensional images of a sample (specimen) placed on a slide to be observed with an optical microscope, by analyzing a feature of the sample and capturing the images while changing the focal position in a direction of an optical axis of the optical microscope based on the information obtained by the analysis.

2. Description of the Related Art

In the field of pathology, a virtual slide system has become to be used as an alternative of an optical microscope as a pathological diagnosis tool. The virtual slide system enables pathological diagnosis on a display by imaging a sample placed on a slide and digitizing the image of the sample. The digitalization of a pathological diagnostic image by the virtual slide system makes it possible to handle a conventional optical microscopic image of the sample as digital data. This provides various advantageous effects. For example, remote diagnosis can be expedited, digital images can be used to give information to patients, rare cases can be shared, and efficiency of education and training can be improved.

In order to realize operation of an optical microscope in a virtual slide system by a virtual technique, the entire image of a sample placed on a slide must be digitized. The digitization of the entire image of the sample makes it possible to observe digital data generated by the virtual slide system with the use of viewer software running on a PC or work station. When the entire image of the sample is digitized, the number of pixels of the digitized image usually becomes as huge as several hundreds of millions to several billions, constituting an enormous volume of data.

Even though the amount of data generated by the virtual slide system is huge, the image can be enlarged or reduced by means of the viewer so that it can be observed both microscopically (in an enlarged detail view) and macroscopically (in an overall perspective view), whereby various conveniences are provided. For example, all the items of necessary information can be preliminarily acquired so that any image from a low-magnification image to a high-magnification image can be instantaneously displayed at any resolution and magnitude the user wants.

Even though the virtual slide system provides various conveniences as described above, it still has some drawbacks in terms of usability in comparison with observation with a conventional optical microscope.

One of such drawbacks relates to observation in a depth direction (a direction along the optical axis of the optical microscope or a direction perpendicular to the observation surface of the slide). Conventionally, when a physician observes a tissue or cell with an optical microscope, he/she obtains a three-dimensional conformation of the tissue or cell by micro-moving the stage in the direction of the optical axis to change the focal position in the sample on the slide. However, since an amount of data of each image is very large in the virtual slide system, it is a general practice to capture an image in a single flat surface (or curved surface), while no image is captured in a depth direction. This implies that capturing a plurality of two-dimensional images at different depths induces problems in terms of both data capacity and imaging time.

If information on depth direction is required, the imaging is performed after presetting the number of images to be captured or an imaging interval. However, since each sample (slide) has a different thickness, a single setting may induce unnecessary increase of data volume or deterioration of throughput (number of images processable in unit time).

Another possible countermeasure is to set imaging conditions in the depth direction individually for each sample by means of human intervention. However, it will take a lot of time and labor to process a large number of images, resulting in deterioration of work efficiency.

There have been proposed the following methods of acquiring information on depth direction.

In the method disclosed in Japanese Patent Application Laid-Open No. 2005-128493, the position of a slide cover glass is measured by means of auto-focus, and a center position is determined by the user's operation. Using the set values for interval and number of images (or range and number of images) designated by the user, a plurality images are obtained while shifting the stage in a depth direction to change the focal position.

Japanese Patent Application Laid-Open No. 2007-316433 discloses a method of acquiring a three-dimensional image data with a magnifying observation apparatus, wherein information on depth of field is obtained from the apparatus, and a plurality of images are obtained while changing the focal position by shifting the stage in a depth direction by a distance corresponding to the depth of field.

However, the aforementioned prior art techniques have problems as described below.

In pathological diagnosis in general, a physician observes a large number of slides. Therefore, hospitals having a large number of diagnosis cases require a virtual slide system having a function of batch processing of a large number of images and capable of digitizing a large number of slides in a short period of time (e.g. in one night).

In the case of the apparatus disclosed in Japanese Patent Application Laid-Open No. 2005-128493, the imaging interval and the number of images to be captured (or the imaging range and the number of images) need be set for each slide, and hence automatic imaging of a large number of images is impossible by this apparatus.

In the case of the apparatus disclosed in Japanese Patent Application Laid-Open No. 2007-316433, automatic imaging of a large number of images is possible by employing a full auto mode in which the number of images to be captured is determined by dividing a height of an object by a depth of field. However, in this method, the imaging is performed at fixed intervals according to the depth of field regardless of a type or state of the sample (object to be observed), resulting acquisition of excessive number of images.

Increase of the number of captured images is not desirable since it possibly incurs increase of data volume or deterioration of processing efficiency (throughput). This problem becomes more serious as the image resolution and size are increased. Nevertheless, if the imaging interval is simply increased in order to reduce the number images to be captured, there maybe a risk that information that requires observation is omitted. Thus, enhancement of efficiency of automatic imaging and prevention of omission of important information are in a trade-off relationship.

### SUMMARY OF THE INVENTION

This invention has been made in view of these problems, and an object of the invention is to realize automatic setting without human intervention and improvement of throughput by reduction of data volume.

The present invention in its first aspect provides an imaging apparatus including: a stage on which an object is placed; an imaging unit having an imaging device, and an imaging optical system for magnifying an image of the object on the stage and guiding the magnified image to the imaging device; a control unit for controlling the stage and the imaging unit; and an image processing unit for processing image data obtained by the imaging unit, wherein: the image processing unit determines the number of images to be captured of the object by analyzing image data obtained by imaging the object on the stage; the control unit performs, according to the number of images to be captured determined by the image processing unit, either first processing for acquiring image data of a single image by imaging the object on the stage, or second processing for acquiring image data of a plurality of images with different focal positions by imaging the object on the stage for a plurality of times while changing the focal position.

The present invention in its second aspect provides an imaging method for use in an imaging apparatus including a stage on which an object is placed, and an imaging unit having an imaging device, and an imaging optical system for magnifying an image of the object on the stage and guiding the magnified image to the imaging device, the method including: a preliminary measurement step of imaging an object on the stage with the imaging unit; a determination step of determining the number of images to be captured of the object by analyzing the image data obtained in the preliminary measurement step; and a main measurement step of performing, according to the number of images to be captured determined in the determination step, either first processing for acquiring image data of a single image by imaging the object on the stage, or second processing for acquiring image data of a plurality of images with different focal positions by imaging the object on the stage for a plurality of times while changing the focal position.

According to the invention, automatic setting without human intervention and improvement of throughput by reduction of data volume can be realized.

Further features of the present invention will become apparent from the following description of exemplary embodiments with reference to the attached drawings.

### BRIEF DESCRIPTION OF THE DRAWINGS

FIG. 1 is a block diagram of a virtual slide system;

FIG. 2A is a configuration diagram of a main measurement unit, and FIG. 2B is a configuration diagram of a preliminary measurement unit;

FIG. 3 is an internal configuration diagram of a host computer;

FIG. 4A is a is a flowchart illustrating main measurement processing according to a first embodiment, and FIG. 4B is a flowchart illustrating preliminary measurement estimation control processing;

FIGS. 5A to 5D are diagrams for explaining imaging regions of main measurement and preliminary measurement;

FIG. 6A is a diagram for explaining directions of X-Y stage movement, and FIG. 6B is a diagram for explaining directions of Z stage movement;

FIG. 7A is a flowchart illustrating preliminary measurement data acquisition processing according to the first embodiment, and FIG. 7B is a flowchart illustrating depth information estimation processing;

FIGS. 8A and 8B are diagrams for explaining a color histogram used for estimation of a stain method according to the first embodiment;

FIG. 9 is a diagram for explaining a method of estimating a stain method according to the first embodiment;

FIG. 10 is a flowchart illustrating imaging condition calculation processing according to the first embodiment;

FIGS. 11A and 11B are diagrams for explaining a method of measuring a sample thickness using a laser displacement meter;

FIG. 12 is a flowchart illustrating Z stage control parameter calculation processing according to the first embodiment;

FIG. 13 is a flowchart of imaging condition calculation processing according to the first embodiment;

FIG. 14 is a flowchart of preliminary measurement data acquisition processing according to a second embodiment;

FIG. 15 is a diagram for explaining depths of field of closed aperture imaging and open aperture imaging according to the second embodiment;

FIGS. 16A to 16C are diagrams for explaining a difference between images obtained by closed aperture imaging and open aperture imaging according to the second embodiment;

FIG. 17 is a flowchart of imaging condition calculation processing according to the second embodiment;

FIG. 18 is a diagram for explaining layering in depth direction according a modification of the second embodiment;

FIG. 19 is a flowchart of preliminary measurement estimation control processing according to a third embodiment;

FIG. 20A is a flowchart of region-of-interest estimation processing according to the third embodiment, and FIG. 20B is a flowchart of individual evaluation value calculation processing;

FIG. 21A is a flowchart of imaging condition calculation processing according to the third embodiment, and FIG. 21B is a flowchart of Z stage control parameter calculation processing; and

FIG. 22 is a flowchart of imaging control processing according to the third embodiment.

### DESCRIPTION OF THE EMBODIMENTS

### First Embodiment

(Overall System Configuration)

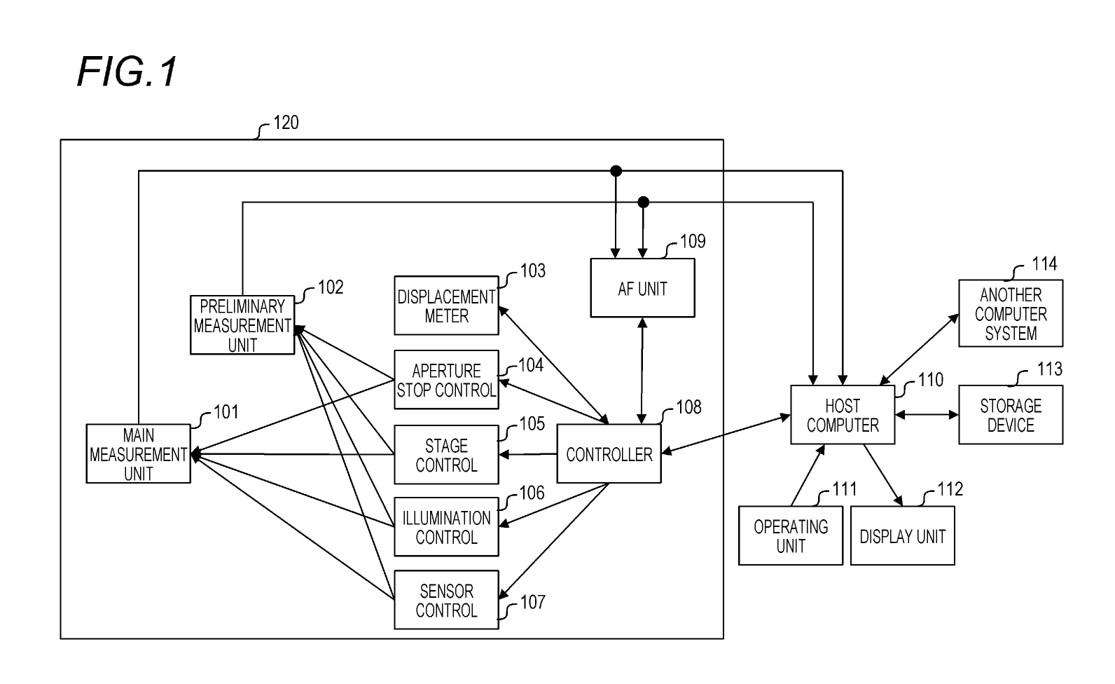

FIG. 1 illustrates a configuration of a virtual slide system as an embodiment of an imaging apparatus (image generating apparatus) of this invention.

The virtual slide system is composed of a virtual slide scanner 120 for acquiring imaging data of a sample (specimen) on a slide, a host computer 110 for performing data processing and control, and peripheral equipment of the host computer 110.

The host computer 110 is connected to an operating unit 111 for accepting input from the user through an operating device such as a key board or a mouse, and a display unit 112 for displaying a processed image.

The host computer 110 is further connected to a storage device 113, and another computer system 114, whereby a large volume of data acquired from the virtual slide scanner 120 can be stored in the storage device 113 or transmitted to the another computer system 114.

Control of the virtual slide scanner 120 can be realized by the host computer 110 transmitting an instruction to a controller 108, and then the controller 108 controlling a main measurement unit 101 and a preliminary measurement unit 102 connected thereto.

The main measurement unit 101 is a unit for acquiring a high-definition image used for diagnosing a sample on the slide. The preliminary measurement unit 102 is a unit for performing imaging prior to the main measurement. The preliminary measurement unit 102 captures an image for the purpose of acquiring control information to enable image acquisition with high precision in the subsequent main measurement. While details will be described later, this invention is characterized by processing in which a plurality of images are captured while changing the focal position in a depth direction by controlling the main measurement unit 101 with the use of the image data captured by the preliminary measurement unit 102.

The image data captured by the main measurement unit 101 and the preliminary measurement unit 102 is transmitted to the host computer 110. The host computer 110 is designed to be capable of processing the transmitted image data. In depth information estimation processing according to this embodiment to be described later, the image captured by the preliminary measurement unit 102 is used as an analysis object and is analyzed by the host computer 110.

The controller 108 is connected to a displacement meter 103 so that a position and distance of a slide placed on the stage within the main measurement unit 101 or preliminary measurement unit 102 can be measured. The displacement meter 103 is used to measure the thickness of a sample on the slide when performing the main measurement and the preliminary measurement.

The controller 108 is also connected to an aperture stop control 104, a stage control 105, an illumination control 106, and a sensor control 107 for controlling imaging conditions of the main measurement unit 101 and the preliminary measurement unit 102. These controls are designed to respectively control the aperture stop, the stage, illumination, and operation of the image sensor according to a control signal from the controller 108.

The stage includes an X-Y stage for moving the slide in a direction perpendicular to the optical axis, and a Z stage for moving the slide in a direction along the optical axis. The X-Y stage is used to capture images of a sample spreading in a direction perpendicular to the optical axis, and the Z stage is used to capture images with different focal positions changed in the depth direction. Although not shown, the virtual slide scanner 120 is provided with a rack in which a plurality of slides can be stowed, and a transport mechanism for feeding a slide from the rack to the imaging position above the stage. When a large number of slides are to be imaged by batch processing, the controller 108 controls the transport mechanism so that the slides are fed one by one from the rack to the stage of the preliminary measurement unit 102 and then to the stage of the main measurement unit 101.

The main measurement unit 101 and the preliminary measurement unit 102 are connected to an AF unit 109 for implementing auto-focus using a captured image. The AF unit 109 is able to find a focusing position by the controller 108 controlling the position of the stages of the main measurement unit 101 and the preliminary measurement unit 102. The auto-focusing method is of passive type using images, wherein a known phase contrast detection method or contrast detection method is used.

In the present embodiment, the main measurement unit 101 and the preliminary measurement unit 102 correspond to a first imaging unit and second imaging unit of this invention, respectively. The controller 108 and the host computer 110 correspond to a control unit and image processing unit of this invention, respectively.

(Main Measurement Unit)

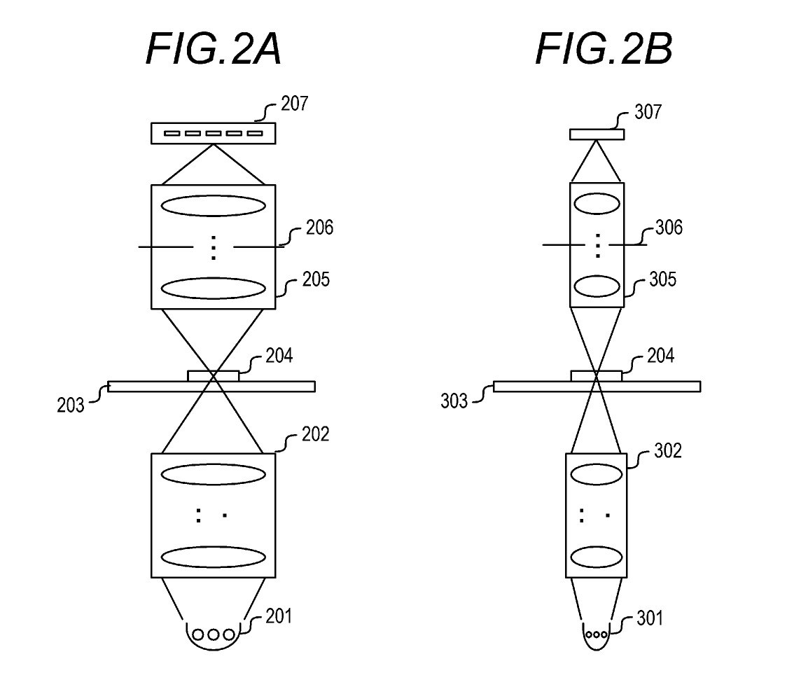

FIG. 2A is a diagram illustrating an internal configuration of the main measurement unit 101 according to the first embodiment.

Light from a light source 201 is passed through an illumination optical system 202 to be uniform and without variation in luminous energy, and applied to a slide 204 placed on a stage 203. The slide 204 is prepared by applying a slice of tissue or smear cell to be observed on a slide glass and fixing the same under a cover glass together with an encapsulant such that the object to be observed (object) is in an observable state.

An imaging optical system 205 is for magnifying an image of an object to be observed and guiding the same to an imaging device 207 serving as imaging means. The light passing through the slide 204 forms an image on the imaging surface of the imaging device 207 through the imaging optical system 205. The imaging optical system 205 includes an aperture stop 206. The depth of field (DOF) can be controlled by adjusting the aperture stop 206.

The image of the content of the slide formed on the imaging surface is opto-electric converted by the imaging device 207 composed of a plurality of image sensors, and then A/D converted. The image is then sent to the host computer 110 as an electric signal. The description of the present embodiment will be made on the assumption that image development processing to be performed after the A/D conversion, including, representatively, noise removal, color conversion processing, and sharpness enhancing processing is performed in the inside of the host computer 110. However, the image development processing may be performed by a dedicated image processing unit (not shown) connected to the imaging device 207, and then data maybe transmitted to the host computer 110. Such an embodiment is also covered by this invention.

(Preliminary Measurement Unit)

FIG. 2B is a diagram illustrating an internal configuration of the preliminary measurement unit 102 according to the first embodiment.

Light from a light source 301 is passed through an illumination optical system 302 to be uniform and without variation in luminous energy, and applied to a slide 204 placed on a stage 303. The light passing through the slide 204 forms an image on the imaging surface of an imaging device 307 by means of an imaging optical system 305. The imaging optical system 305 includes an aperture stop 306, so that the depth of field can be controlled by adjusting the aperture stop 306.

The image of the content of the slide formed on the imaging surface is opto-electric converted by the imaging device 307 having an image sensor, and then A/D converted. The image is then sent to the host computer 110 as an electric signal. The description of the present embodiment will be made on the assumption that image development processing to be performed after the A/D conversion, including, representatively, noise removal, color conversion processing, and sharpness enhancing processing is performed in the inside of the host computer 110. However, the image development processing may be performed by a dedicated image processing unit (not shown) connected to the imaging device 307, and then data may be transmitted to the host computer 110. Such an embodiment is also covered by this invention.

(Host Computer)

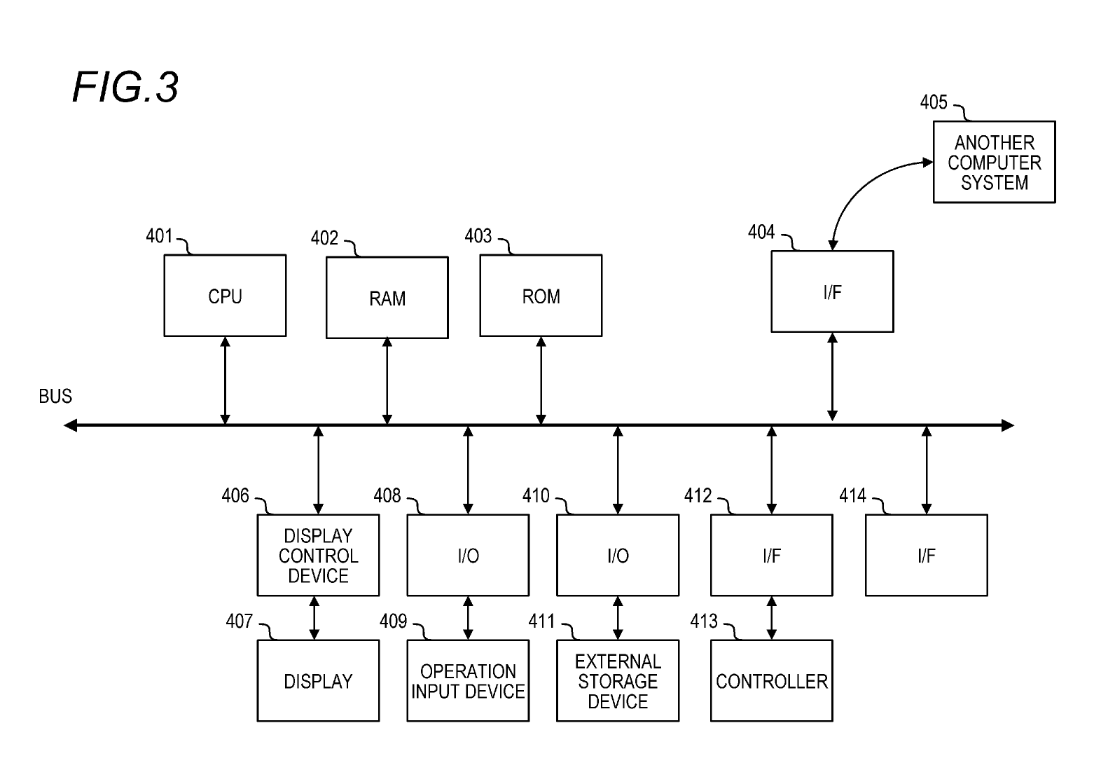

FIG. 3 is a diagram illustrating an internal configuration of the host computer 110 according to this invention.

A CPU 401 controls the entire of the host computer by using a program or data stored in a RAM 402 or ROM 403. The CPU 401 also performs various types of arithmetic processing and data processing to be described in the following description of the embodiment, for example, depth information estimation processing and imaging condition calculation processing.

The RAM 402 has an area for temporarily storing a program and data loaded from an external storage device 411, as well as a program and data downloaded from another computer system 405 via an I/F (interface) 404. The RAM 402 has a work area for the CPU 401 to perform various types of processing. The ROM 403 stores a computer function program, setting data and so on. A display control device 406 performs control processing to cause a display 407 to display images and characters. The display 407 displays a screen to prompt the user to input, and also displays an image of the image data acquired from the virtual slide scanner 120 and processed by the CPU 401.

An operation input device 409 is formed of a device such as a keyboard or a mouse which is capable of inputting various instructions to the CPU 401. The user inputs information for controlling operation of the virtual slide scanner 120 through the operation input device 409. The reference numeral 408 indicates an I/O for notifying the CPU 401 of various instructions or the like which are input through the operation input device 409.

The external storage device 411 is a mass information storage device like a hard disc, which stores an OS (operating system), a program for causing the CPU 401 to perform processing to be described in the following description of the embodiment, and image data obtained by scanning by batch processing.

Writing of information into the external storage device 411 and retrieval of information from the external storage device 411 are performed by way of the I/O 410. The controller 413 is a unit for controlling the virtual slide scanner 120, and exchanges a control signal and response signal with the CPU 401 via an I/F (interface) 412.

The controller 413 has a function to control the main measurement unit 101 and the preliminary measurement unit 102. An I/F (interface) 414 is connected to an interface other than those described above, for example an external interface for importing data output from a CMOS image sensor or a CCD image sensor. The interface used herein may be a serial interface such as a USB or IEEE1394, or a camera link interface. Various peripheral devices can be connected to the host computer via this I/F 414.

(Main Measurement Processing)

The virtual slide system according to the present embodiment performs “preliminary measurement” for determining conditions for imaging a sample (for example, the number of images to be captured) and “main measurement” for imaging the sample with high resolution. In the main measurement, either first processing or second processing can be performed. The first processing is for acquiring data of a single image from the sample, while second processing is for acquiring data of a plurality of images having different focal positions by imaging the sample for a plurality of times while changing the focal position (referred to as Z-stacking). It is determined which of the first processing and the second processing is to be performed according to the imaging conditions determined based on the image obtained by the preliminary measurement. Herein, the processing to determine imaging conditions by analyzing the image data obtained by the preliminary measurement and to control the main measurement unit 101 according to the determined imaging conditions shall be referred to as the “preliminary measurement estimation control processing”.

The following description of the processing will be made firstly of the main measurement processing and then of the preliminary measurement estimation control processing which characterizes the present embodiment, although the actual processing is performed in the reverse sequence.

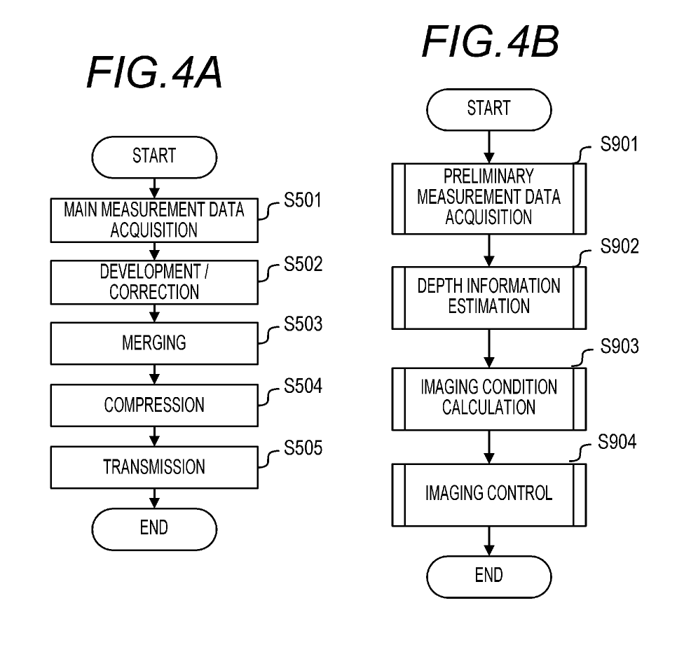

FIG. 4A is a diagram illustrating a flow of the main measurement processing.

In main measurement data acquisition processing S501, the main measurement unit 101 captures an image of the slide under the control of the controller 108 and transmits the image data to the host computer 110.

Subsequently, in development/correction processing S502, the host computer 110 performs, on the image data, various types of processing including color conversion processing, sharpness enhancing processing, and noise reduction processing, whereby colors of the monitor-displayed image can be approximated to the real colors of the sample, and the noise in the image can be reduced.

In merging processing S503, the host computer 110 joins image sections captured by dividing the object surface to form an image of a target region (for example, a region of 20×20 mm) on the slide.

Next, in compression processing S504, the host computer 110 compresses the merged data to reduce the data volume. The compression method applicable here includes a still image compression/coding method such as JPEG or JPEG2000. Subsequently, in transmission processing S505, the host computer 110 transmits the image data to the storage device 113 to store the same in the storage device 113. Alternatively, the host computer 110 may transmit the image data to a computer system 114 or an image server on the network through a network I/F.

(Main Measurement Processing: Main Measurement Data Acquisition Processing S501)

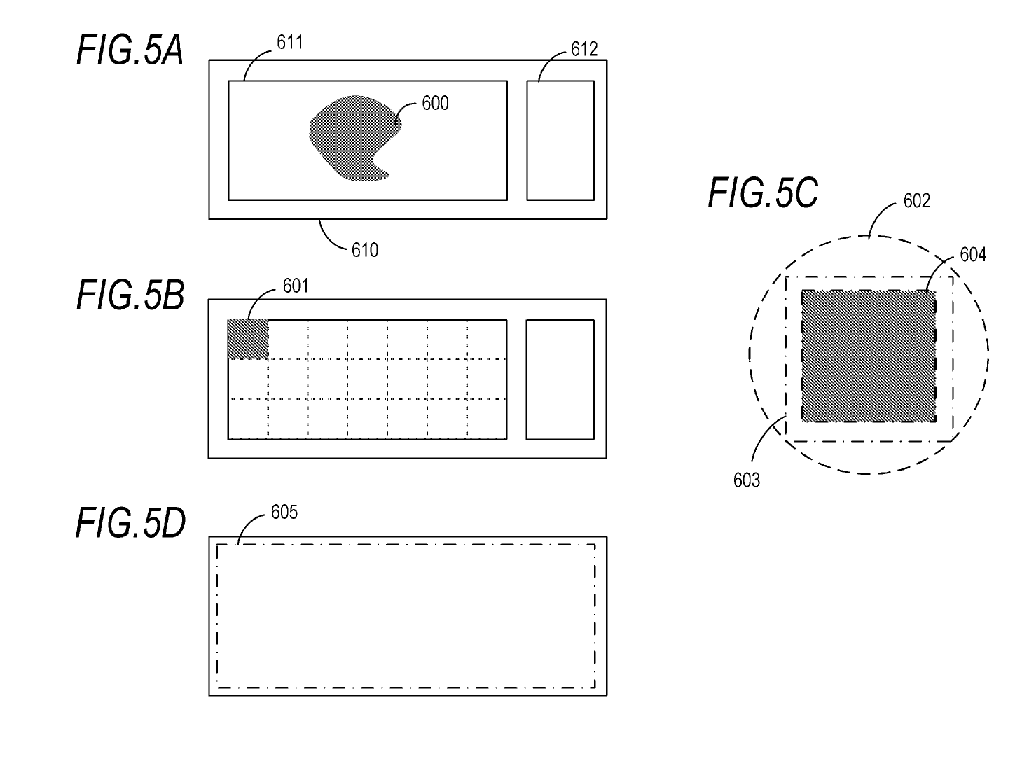

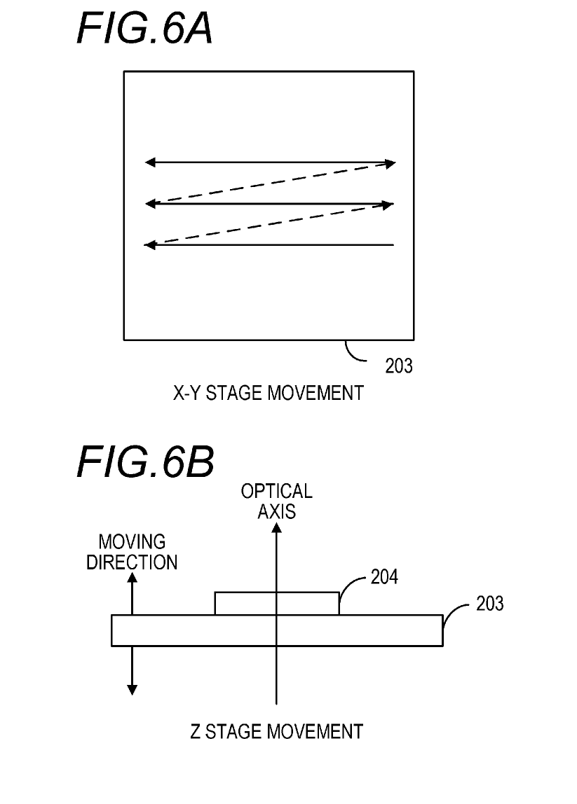

The main measurement data acquisition processing S501 will be described with reference to FIGS. 5A to 5D, and FIGS. 6A and 6B.

FIG. 5A is a schematic diagram of a slide. There are, on a slide glass 610, an area where a sample 600 is enclosed under a cover glass 611 and a label area 612. In the main measurement data acquisition processing S501 according to the present embodiment, the region where it is assumed that the cover glass 611 exists is the region to be imaged. It is preferable to reduce the data volume by finding a circumscribing rectangular region where the sample 600 exists in the preliminary measurement, and imaging only that region in the main measurement.

FIG. 5B illustrates how the region where the cover glass 611 exists is segmented into a plurality of sections and imaged in the main measurement data acquisition processing S501. FIG. 5C shows the imaging surface. An effective field of view 602 indicates an area in which the image can be viewed through the imaging optical system 205 of the main measurement unit 101, a sensor effective region 603 indicates an area in which the image can be captured by the image sensor of the imaging device 207.

An imaging region 601 (shaded area) in the object surface, whose image is formed through the imaging optical system 205 of the main measurement unit 101, corresponds to the imaging region 604 in the imaging surface.

As shown in FIG. 5C, a slightly broader area is assigned to the sensor effective region 603 than the imaging region 604. This is a margin to allow optical aberration of the imaging optical system 205 and deviation of position where the image sensor is attached. This means that, even if there is optical aberration or deviation of the position where the sensor is attached, the imaging region 601 on the object surface is contained within the sensor effective region 603. In the merging processing S503, correction of aberration or positional deviation is performed on the image of the sensor effective region 603, and a portion corresponding to the imaging region 604 is extracted from the corrected image to be used for merging of the images.

FIG. 6A illustrates directions and sequence in which the stage 203 is moved in the XY direction when the segmented area shown in FIG. 5B is imaged in a raster scan sequence. In order to image a lower-right section of the slide from the left side above the slide, the stage 203 on which the slide is mounted is moved in the opposite direction, that is, from the lower right to the upper left.

Thus, a wide area can be imaged with a relatively small-sized image sensor by segmenting the imaging region into a plurality of sections and imaging these sections while moving the stage 203.

FIG. 6B shows direction in which the stage 203 is moved in the Z direction (depth direction) when a plurality of images are captured with different focal positions (depths of observation, or focusing positions) in the main measurement data acquisition processing S501. As shown in FIG. 6B, in order to shift the focal position to the upper side of the sample in the slide 204 (to the rear side of the cover glass), the stage 203 is moved downward in the Z direction along the optical axis of the imaging optical system 205. In contrast, in order to shift the focal position to the lower side of the sample (to the top side of the slide glass), the stage 203 is moved upward in the Z direction. This processing of acquiring image data of a plurality of images with different focal positions by imaging the sample for a plurality of times while changing the focal position is generally referred to as “Z-stacking”.

For the purpose of simplification, the following description will be made only of a configuration in which the focal position is changed by moving the stage 203 in the Z direction. However, the focal position can be changed by moving the imaging device 207, or both of the imaging device 207 and the stage 203 along the optical axis of the imaging optical system 205. Further, the focal position can be changed by controlling the lens of the imaging optical system 205 to optically change the focal distance. Since the stage mechanism of the preliminary measurement unit 102 is substantially the same as that of the main measurement unit 101, description thereof will be omitted.

(Preliminary Measurement Estimation Control Processing)

FIG. 4B is a diagram illustrating a flow of preliminary measurement estimation control processing.

In preliminary measurement data acquisition processing S901, the preliminary measurement unit 102 images the slide under the control of the controller 108, and transmits the image data to the host computer 110.

Next, in depth information estimation processing S902, the host computer 110 analyzes the image captured by the imaging device 307 and estimates a three-dimensional depth of the object. This depth information estimation processing S902, which is a feature characterizing the present embodiment, will be described later in detail with reference to a drawing.

In imaging condition calculation processing S903, the host computer 110 determines and outputs Z stage control parameters based on the information estimated by the depth information estimation processing S902. These parameters are those used in the main measurement by the controller 108 for performing stage control in depth direction, and consist of a shift start position indicating a position to start imaging, a shift interval indicating a distance to shift at each time in a depth direction, and the number of images to be captured.

Finally, in imaging control processing S904, the controller 108 controls the position of the stage 203 of the main measurement unit 101 using the Z stage control parameters calculated by the imaging condition calculation processing S903. Then, focusing at a desired position in the sample interposed between the slide glass and the cover glass, the main measurement unit 101 repeats imaging. Then, a high resolution composite image is generated by the main measurement processing described in FIG. 4A.

FIG. 5D shows an imaging region 605 of the slide 204 in the preliminary measurement. The preliminary measurement has a purpose of acquiring control information for imaging the main measurement with high precision. What is required for the preliminary measurement is to obtain rough understanding of features of the image, and the magnification need not be as high as that in the main measurement. The depth of field should be large in the preliminary measurement, which makes it easy to focus on the sample.

In the preliminary measurement of the present embodiment, the entire of the slide 204 is imaged at a low magnification. Unlike the main measurement, the entire of the slide 204 is collectively imaged with a single image sensor without being segmented into a plurality of sections. This makes it possible to simplify the configuration of the preliminary measurement unit 102, and to reduce the time required for the preliminary measurement and hence the time required the imaging processing as a whole, including the preliminary measurement and the main measurement. However, if a resolution as high as that of the main measurement is required in the preliminary measurement, the magnification may be increased to the same level as in the main measurement, and the imaging may be performed while segmenting the region to be imaged on the surface of the object into a plurality of sections.

(Preliminary Measurement Estimation Control Processing: Preliminary Measurement Data Acquisition Processing S901)

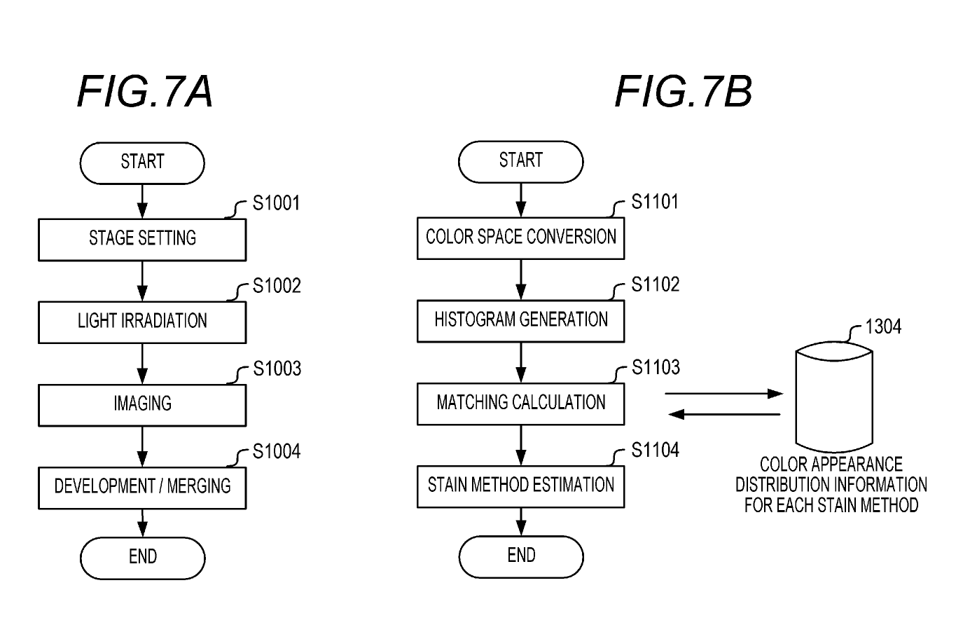

FIG. 7A illustrates details of the preliminary measurement data acquisition processing S901 according to the present embodiment.

In stage setting processing S1001, the controller 108 controls the transport mechanism to set the slide 204 on the stage 303 of the preliminary measurement unit 102.

In light irradiation processing S1002, the light source 301 is turned on to irradiate the slide 204 with light. In an imaging processing S1003, the light is focused on the imaging surface after passing through the illumination optical system 302, the slide 204, and the imaging optical system 305, and formed into an image by the image sensor of the imaging device 307. According to the present embodiment, the image is exposed sequentially to three different light sources 301, namely RGB light sources, and images are captured three times, whereby a color image is obtained. This means that the processing steps of S1002 and S1003 are repeated three times.

In development/merging processing S1004, the host computer 110 performs development/merging processing on raw data obtained in the imaging processing S1003. In the development/merging processing S1004, color conversion, noise removal processing and other processing are performed. There are various color space standards such as sRGB and Adobe RGB. While any of them may be used, the colors are converted into a sRGB color space which is representative of them in the present embodiment.

(Preliminary Measurement Estimation Control Processing: Depth Information Estimation Processing S902)

FIG. 7B illustrates details of depth information estimation processing S902 which constitutes a feature characteristic of the present embodiment. The depth information estimation processing according to the present embodiment is processing for estimating a method of staining the sample based on the colors of the image data obtained in the preliminary measurement.

Firstly, in color space conversion processing S1101, a color space conversion is performed on the image data obtained in the preliminary measurement. The color space includes, xyY colorimetric system (xy chromaticiy diagram), luminance/chrominance signal YUV, uniform color space CIE L*a*b*, HSV color space, HLS color space, and so on. In the present embodiment, the image data is converted into the CIE L*a*b* color space. If the subsequent processing is to be performed while the image data remains in sRGB, the processing step of S1101 may be omitted.

In histogram generation processing S1102, the host computer 110 generates a color histogram (color appearance distribution information) from the image data which has been subjected to the color space conversion.

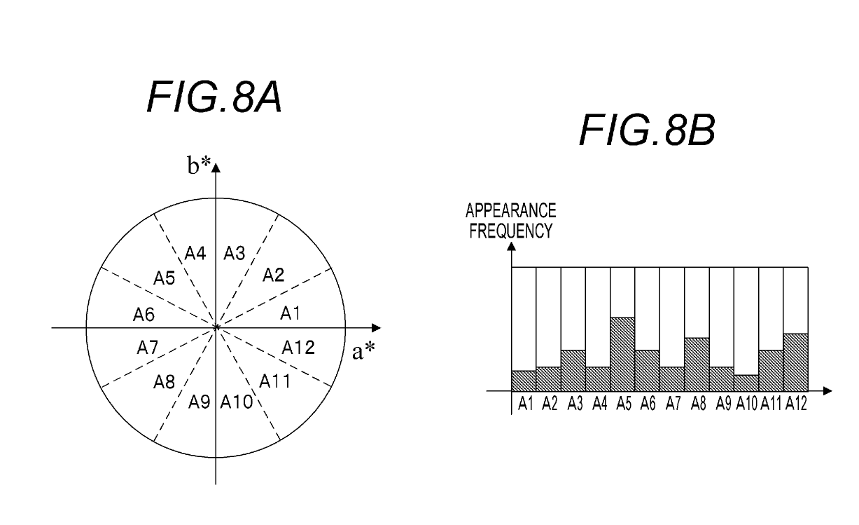

FIGS. 8A and 8B illustrate an example of the histogram generation processing S1102. As shown in FIG. 8A, for example, the L*a*b* color space is segmented equally into 12 sections of 30 degrees each around the L* axis, and numbers of pixels appearing in the respective sections A1 to A12 are counted. As shown in FIG. 8B, a one-dimensional histogram is drawn for the image data obtained in the preliminary measurement. The horizontal axis of FIG. 8B indicates the sections A1 to A12, and the vertical axis indicates the frequency of appearance of pixels (the number of pixels).

As seen from FIGS. 5A and 5D, the preliminary measurement imaging region 605 includes an area where the sample 600 is not present. The area where the sample 600 is not present assumes a color of the illumination, namely an achromatic color. The precision of estimation of the sample staining method can be improved by removing pixels not pertinent to the sample. Therefore, the pixels present at a predetermined distance (pixels of a substantially achromatic color) from the L* axis should be removed from the histogram.

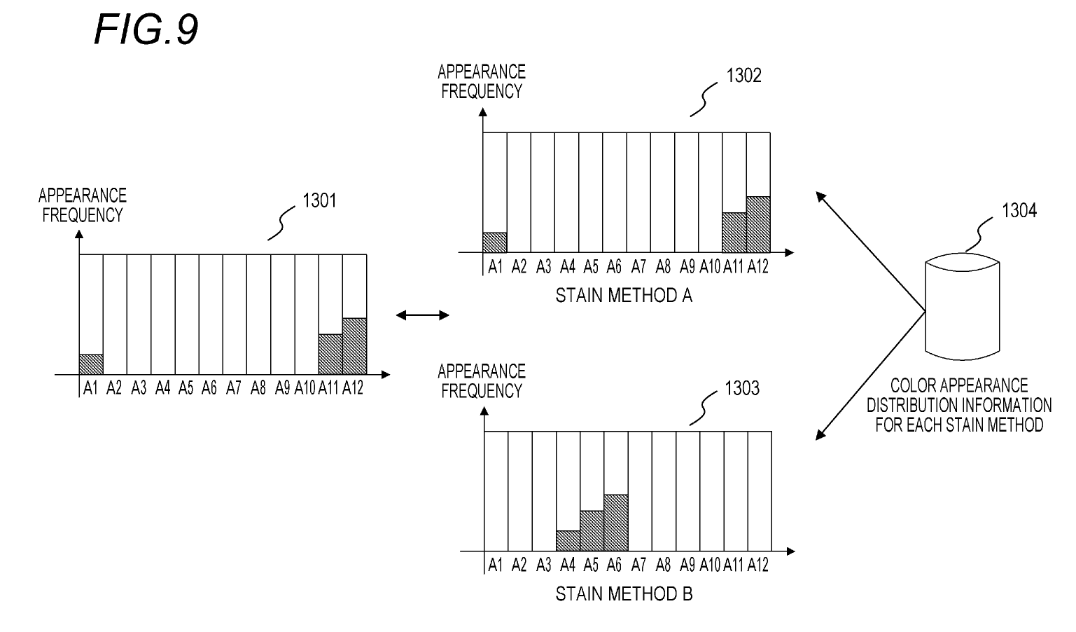

In matching calculation processing S1103, the host computer 110 acquires, from a data base 1304, a color histogram (color appearance distribution information) for each stain method. There are preliminarily stored in the data base 1304 color histograms prepared using some samples of the respective stain methods and indicating a typical color appearance distribution of each of the stain methods. In FIG. 9, the reference numeral 1302 indicates a color histogram of a stain method A, 1303 indicates a color histogram of a stain method B. The host computer 110 compares the histogram 1301 calculated in the histogram generation processing S1102 with the typical histograms 1302 and 1303 of the respective stain methods and calculates a matching for each of the stain methods.

A matching (similarity) between histograms can be evaluated by taking an inner product between the histograms or a histogram intersection. By using normalized cross-correlation (by normalizing the total sum of one-dimensional histogram to be zero before calculating the inner product), the maximum value of the inner product can be suppressed to one, which facilitates introduction of a threshold for determination in the following step, and makes it possible to eliminate less accurate estimation.

In stain method estimation processing S1104, a stain method which exhibits the highest matching is selected as the stain method for the sample which has been subjected to the preliminary measurement. For example, in the example shown in FIG. 9, the color histogram 1301 of the sample which has been subjected to the preliminary measurement assumes the greatest inner product (correlation) with the color histogram 1302 of the stain method A.

In the stain method estimation processing S1104, it can be determined that “the stain method is unknown” when the maximum matching is smaller than the predetermined threshold. If a stain method which is not the one for the sample is erroneously selected, the setting of appropriate imaging conditions likely becomes impossible. Therefore, it is desirable to introduce a threshold in order to reduce the probability of erroneous determination.

Information on the stain method determined in the stain method estimation processing S1104 is stored in an appropriate location such as the RAM 402 or the external storage device 411 accessible by the host computer 110. A data base 1304 for storing the color histogram for each of the stain methods may be located either within the external storage device 411 or within another computer system 405.

(Preliminary Measurement Estimation Control Processing: Imaging Condition Calculation Processing S903)

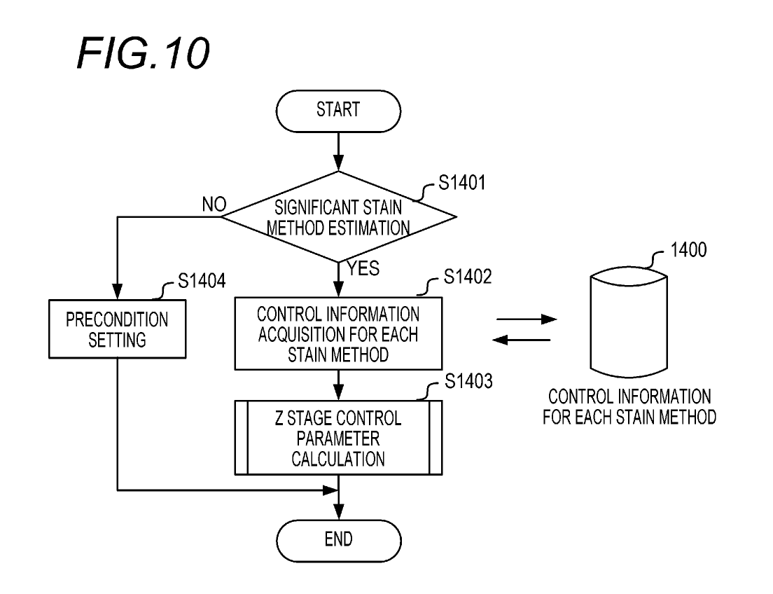

FIG. 10 illustrates details of the imaging condition calculation processing S903.

Firstly, in S1401, the host computer 110 determines whether or not significant stain method estimation could be performed. If highly accurate estimation was performed, the processing proceeds to S1402, and the host computer 110 accesses the data base 1400 to acquire control information for each of the stored stain methods. Subsequently, in S1403, the host computer 110 calculates Z stage control parameters which are parameters for controlling the displacement distance in the depth direction in the main measurement based on the control information acquired in S1402. In contrast, if it is determined in S1401 that a stain method estimation could not be performed significantly (that is, the stain method is unknown), the host computer 110 performs precondition setting in S1404 for setting a predetermined default condition.

The control information acquired in S1402 for each stain method will be described in more detail.

The control information for each stain method is information consisting of “stain method”, “the number of images to be captured”, “thickness of sample”, “shift start position”, “shift interval”, and “calculation mode”. The data base 1400 according to the present embodiment stores data indexed by stain methods for example in the manner as described below.

(HE staining, one image, 3 μm, center, 0 μm, number-of-images designated)

(Papanicolaou staining, 9 images, 20 μm, upper end, 2.5 μm, depth designated)

(Giemsa staining, 9 images, 20 μm, upper end, 2.5 μm, depth designated)

HE staining (Hematoxylin and Eosin staining) is a stain method commonly used for overall observation of a tissue slice in tissue biopsy. In general, a sample tends to assume a uniform thickness when sliced thinly, and hence one image will suffice to be captured. Since Papanicolaou staining and Giemsa staining are stain methods used in cell biopsy, the sample thickness tends to be greater. Therefore, it is desirable to capture a plurality of images at intervals of several μm. Focusing on the correlation between stain method and imaging conditions (the number of images and shift interval), the present embodiment employs a method in which adequate imaging conditions are set according to a stain method estimated based on the color distribution in the preliminary measurement image.

As for the sample thickness, not only the sample thickness contained in the control information but also a value of sample thickness measured with another means can be used. For example, when the displacement meter 103 such as a laser displacement meter is used, the sample thickness can be measured with the use of information on surface or rear-face reflection of the slide glass or cover glass.

The shift start positions include “center”, “upper end” and “lower end”. The “center” position indicates a position obtained by adding a half the sample thickness to the surface position of the slide glass. The “upper end” position indicates the position of the rear face of the cover glass, and the “lower end” position indicates the surface position of the slide glass. The actual position is obtained by calculation based on a measured value by the displacement meter 103.

The calculation modes consist of three modes of “number-of-images designated”, “interval designated” and “depth designated”. Different imaging control parameter calculation methods are used for these modes, respectively.

The aforementioned control information may be set different for each physician or each medical center. Alternatively, the user may set the control information every time before starting a series of batch processing steps. Although the sample thickness depends on a method of preparing a sample, the thickness tends to assume a fixed value in tissue biopsy since the sample is generally prepared by thinly slicing the sample, whereas in cell biopsy, the thickness tends to become greater since an acquired cell is smeared on the slide glass.

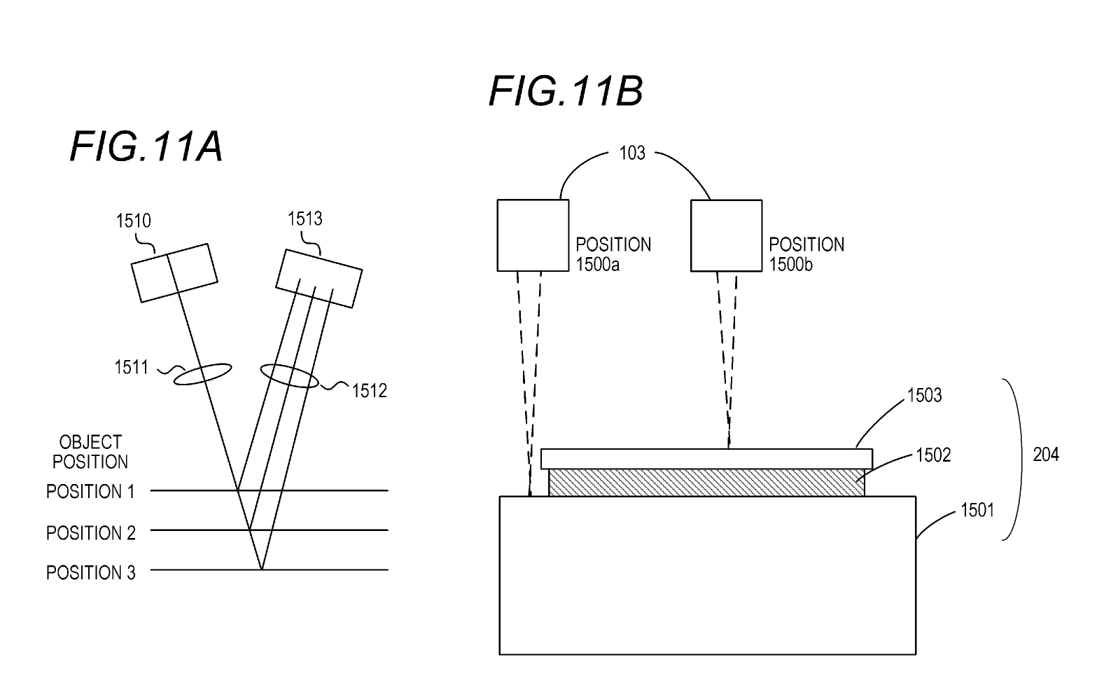

FIG. 11A is a diagram illustrating a configuration for measuring sample thickness with the use of the laser displacement meter 103. In the laser displacement meter 103, light emitted from a projection element 1510 passes through a projection lens 1511 and is reflected (or diffused) by an object to be measured. The reflected (or diffused) light is received by a position detection element 1513 via a reception lens 1512. The light reception position differs depending on the position of the object to be measured. The difference in position at the position detection element 1513 is proportional to the difference in depth direction of the object to be measured. Thus, the position of the object can be obtained by using the principle of triangulation.

Next, referring to FIG. 11B, a method of obtaining a sample thickness with the use of the laser displacement meter 103 will be described. Light reflected from the surface of the slide glass 1501 of the slide 204 is detected at a position 1500a close to an end of the slide 204. The stage is then shifted so that light reflected from the surface of a cover glass 1503 is detected at a substantially central position 1500b of the slide 204. A sum of the thicknesses of the cover glass 1503 and the sample 1502 is obtained by using the principle of triangulation based on the difference in light receiving position by the position detection element 1513 between the light reflected from the surface of the slide glass 1501 and the light reflected from the surface of the cover glass 1503. When it is assumed that the thickness of the cover glass 1503 is known, the thickness of the sample 1502 can be obtained. The thickness of the cover glass 1503 can also be obtained by correcting the displacement of the cover glass obtained from the light reflected from the surface and rear face of the cover glass 1503 with an index of refraction of the glass.

Thus, even if erroneous determination is made, it can be prevented that imaging is performed out of the range where the sample is present by comparing the sample thickness obtained by the laser displacement meter 103 with the sample thickness described in the control information.

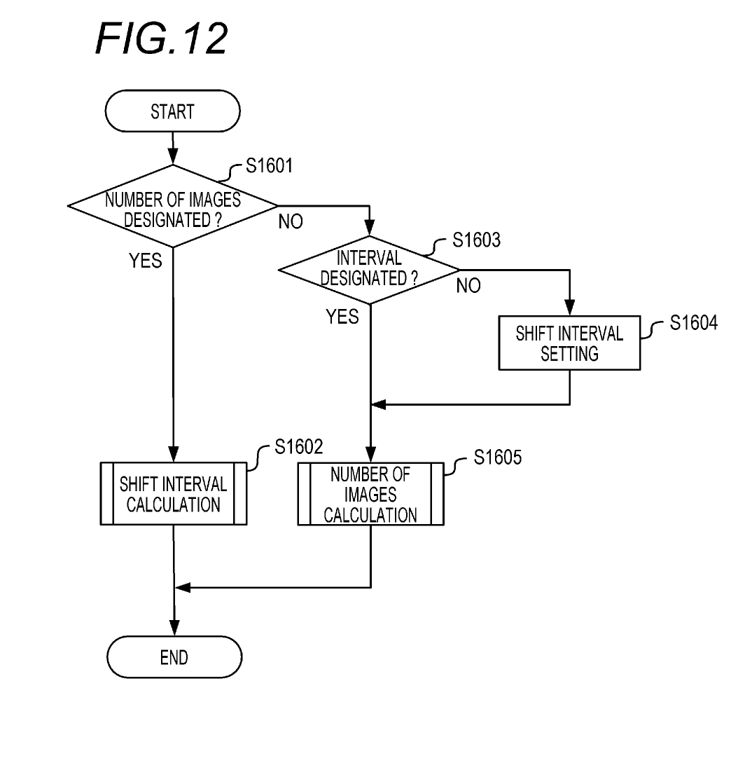

Next, description will be made on difference in the calculation method according to the calculation mode, with reference to FIG. 12.

In S1601, the host computer 110 determines whether or not the calculation mode is the “number-of-images designated” mode. When it is the “number-of-images designated” mode, the host computer 110 calculates in S1602 a shift interval by dividing the sample thickness by the number of images to be captured described in the control information.

When the sample thickness is denoted by T [μm], the number of images to be captured is denoted by N, and the shift interval is denoted by S [μm], the shift interval S is represented as S=0 [μm] when N=1, whereas it is represented as S=T/(N−1) [μm] when N>1.

When it is determined that the calculation mode is not the “number-of-images designated” mode, the processing proceeds to S1603, the host computer 110 determines whether or not the calculation mode is the “interval designated” mode. When it is the “interval designated” mode, the processing proceeds to S1605, whereas when it is not so (that is, it corresponds to the “depth designated” mode), the processing proceeds to S1604. In S1604, the host computer 110 sets the value of the depth of field of the main measurement unit 101 to the shift interval. In S1605, the number of images to be captured is calculated based on the value set at this point of time.

The number of images N is represented as N=1 when T<S. When T S and the shift start position is at the upper or lower end, it is represented by the formula:

N=CEIL(T/S)+1 (1).

When T≧S and the shift start position is at the center, it is represented by the formula:

N=2×CEIL(T/2/S)+1 (2).

In the formulae above, CEIL(X) represents a function for obtaining a minimum integer of not less than X.

The formula (1) includes the term “+1” so that both the upper and lower ends of the sample are invariably included within the imaging range. For example, when the shift start position is the lower end, and T=3 μm and S=2 μm, the number of images to be captured is three. Although the position where the third image is to be captured is above the upper end of the sample, the range where the sample is present is nonetheless covered. A similar concept is employed in the formula (2) as well, wherein the number of images required to cover the thickness T/2 corresponding to the distance from the center to one of the ends (CEIL(T/2/S)+1) is obtained, the result is multiplied by 2, and one of the overlapping images at the center is subtracted. The aforementioned formulae are illustrative only, and various modifications are possible. For example, if T/S in the formula (1) does not assume an integer value, the shift interval may be set to T−S×(N−2) instead of the shift interval S between the (N−1)-th image and N-th image, in order to enable image capturing at both the upper and lower ends of the sample.

The depth of field (DOF) is an allowable range for the position of an object in which a clear image can be formed on the image surface when the position of the image surface is fixed. The depth of field indicates a range in which the image comes into focus on the optical axis of the object, and is in a correspondence relationship with a depth of focus which is a range in which the image comes into focus in the direction of the optical axis of the image surface.

The depth of field can be calculated based on the state of the imaging optical system 305 and the aperture stop 306 of the preliminary measurement unit 102. However, it is troublesome to use sequential calculations to obtain the same. Therefore, a data base of depth of field may be preliminarily prepared by calculating the depth of field separately for each of the imaging conditions such as focal position and aperture stop, so that the host computer 110 retrieves a value of the depth of field from the data base as necessary.

In order to facilitate understanding, specific example of calculation of the Z stage control parameters is described below.

For example, it is assumed that the depth of field of the imaging optical system 305 is 0.5 μm, the stain method estimated by the preliminary measurement is Papanicolaou staining, and control information of (Papanicolaou staining, 9 images, 20 μm, upper end, 2.5 μm, depth designated) is obtained.

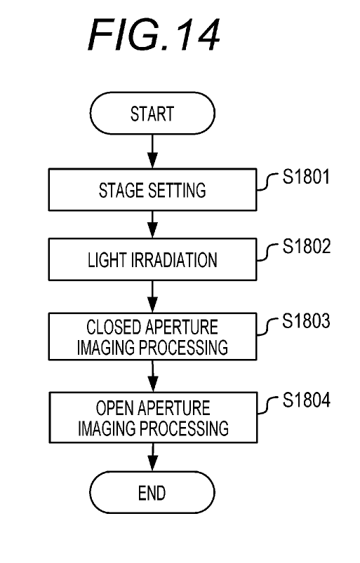

Since the condition of “depth designated” mode is set, the shift interval is set to the depth of field of 0.5 μm in S1604 of FIG. 14, and the number of images to be captured N is obtained according to the formula (1) as follows:

N=CEIL(20 [μm]/0.5 [μm])+1=41.

Accordingly, the calculated Z stage control parameters are as follows:

(Shift start position, shift interval, number of images)=(upper end, 0.5 μm, 41).

It is now assumed that the stain method estimated by the preliminary measurement is HE staining, and control information of (HE staining, one, 3 μm, center, 0 μm, number-of-images designated) is obtained.

Although a shift interval is calculated in S1602 since the condition of “number-of-images designated” mode is set, the shift interval is 0 μm because N=1.

Accordingly, the calculated Z stage control parameters are as follows:

(Shift start position, shift interval, number of images)=(center, 0 μm, 1).

In the manner as described above, the number of images to be captured and the imaging interval are can be set adequately according to a sample stain method. Specifically, when Papanicolaou staining which requires observation in depth direction is employed, a plurality of images are captured at short shift intervals. In contrast, when HE staining which does not require observation in depth direction is employed, the number of images can be set to one to suppress the data volume.

(Preliminary Measurement Estimation Control Processing: Imaging Control Processing S904)

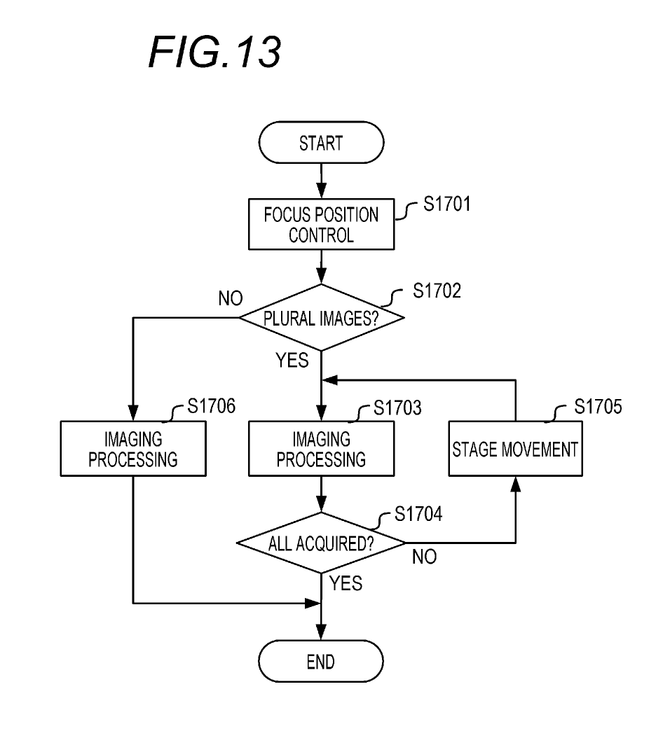

FIG. 13 illustrates internal processing of the imaging control processing S904.

In S1701, the controller 108 controls the transport mechanism to shift the slide 204 from the preliminary measurement unit 102 onto the stage 203 of the main measurement unit 101. The controller 108 then refers to the Z stage control parameters calculated in S903 and controls the focus position of the main measurements unit 101. For example, if the shift start position is “lower end”, the focus position is set to the upper end of the slide glass. If the shift start position is “center”, the focus position is set to a position shifted from the upper end of the slide glass toward the inside of the sample by a distance corresponding to a half of the sample thickness. If the shift start position is “upper end”, the focus position is set to a position shifted from the upper end of the slide glass toward the inside of the sample by a distance corresponding to the thickness of the sample.

Next, in S1702, the controller 108 determines whether or not the number of images to be captured is greater than one. If the number is one, the processing proceeds to S1706, an image at the current focus position is captured by the current main measurement unit 101 and the processing is terminated.

If the number of images to be captured is greater than one, the processing proceeds to S1703, and imaging is performed by the main measurement unit 101. In S1704, the controller 108 determines whether or not all the necessary images have been captured and, if not, the processing proceeds to S1705. In S1705, the controller 108 shifts the stage 203 in a depth direction by the shift interval based on the Z stage control parameters. As a result, the focus position is shifted in the thickness direction of the sample by a distance corresponding to the shift interval. After that, another imaging is performed in S1703. The processing steps of S1703 to S1705 are repeated until the number of images designated by the Z stage control parameter is attained.

The image data acquired by the main measurement unit 101 is transmitted to the host computer 110. The image data obtained with varied depth directions maybe stored and managed as a separate file for each of the depth positions, or may be stored and managed collectively in a single file.

According to the method of the first embodiment described above, the method of staining the sample is estimated by the preliminary measurement so that an adequate number of images to be captured, shift interval, and imaging method can be set automatically based on the estimated stain method. This provides advantageous effects of reducing the data volume (the number of images to be captured) and improving the throughput in both transmission and storage of data. Since a plurality of images are captured when observation in a depth direction is required, it is possible to prevent the lack of information required for the observation.

This eliminates the need of human intervention to make determination for each slide even when a large number of slides including those stained at various sites with various stain methods by the virtual slide system are to be imaged by batch processing. As a result, an effect of reducing the amount of efforts required for imaging can be realized.

The method of the present embodiment further provides an advantage that it is not only applicable to the existing stain methods but also applicable to a novel stain method easily. When a novel stain method is developed, what is required is only to generate a color histogram for the novel stain method as shown in FIG. 9 and add the same to the data base 1304.

Although the description of the present embodiment has been made in terms of the method of determining the stain method by color-converting information of an image captured with three colors of RGB, this invention is not limited to this method. For example, the stain method may also be specified by acquiring spectra (spectral characteristic) data of the sample in the preliminary measurement, and comparing the acquired spectra data with spectra data stored in the data base 1304 for each of the stain methods. The comparison of spectra makes it possible to distinguish the stain methods more accurately than the method using colors.

### Second Embodiment

In a second embodiment, the same effects as those of the first embodiment are realized by using different means from that of the first embodiment to estimate depth information by the preliminary measurement.

Like the first embodiment, the flow of preliminary measurement estimation control processing according to the second embodiment is represented by FIG. 4B, while internal processing in the respective steps of FIG. 4B is slightly different from the first embodiment.

(Preliminary Measurement Estimation Control Processing: Preliminary Measurement Data Acquisition Processing S901)

Firstly, referring to FIG. 14, the preliminary measurement data acquisition processing S901 according to the second embodiment will be described.

In stage setting processing S1801, the controller 108 controls the transport mechanism to set the slide 204 on the stage 303 of the preliminary measurement unit 102. The light source 301 is then turned on in light irradiation processing S1802. Subsequently, in closed aperture imaging processing S1803, the sample is imaged with the aperture stop closed down to some extent. In open aperture imaging processing S1804, the sample is imaged with the aperture stop opened more than in S1803. This means that the sample is imaged a plurality of times with different aperture sizes (F values). As a result, in the preliminary measurement data acquisition processing S901, a plurality of preliminary measurement images (two images in the present embodiment) are obtained, which are the same in focal position and number of pixels but different in depth of field.

(Preliminary Measurement Estimation Control Processing: Depth Information Estimation Processing S902)

Internal processing of the depth information estimation processing S902 will be described. Unlike the first embodiment, the depth information estimation processing S902 according to the second embodiment is characterized by using an image quality evaluation index to evaluate a difference between two images obtained in the preliminary measurement data acquisition processing S901.

Image quality evaluation can be performed by using a method in which a standard deviation of an image as a whole is simply obtained from an absolute value of a difference between pixels of two images. It is also possible to employ an objective evaluation index well known in the field of image quality evaluation, such as PSNR (Peak Signal-to-Noise Ratio) or SSIM (Structural Similarity). In order to eliminate the influence of sensor noise, a captured image maybe subjected to filtering processing with a median filter or the like before conducting image quality evaluation.

Further, since a focused image area is used as a target for comparison, the image may be subjected to frequency filtering (with a bandpass filter or highpass filter) for extracting a medium frequency component or high frequency component before conducting image quality evaluation.

The calculated image quality evaluation index value is stored in a RAM 402 or other adequate location on a computer.

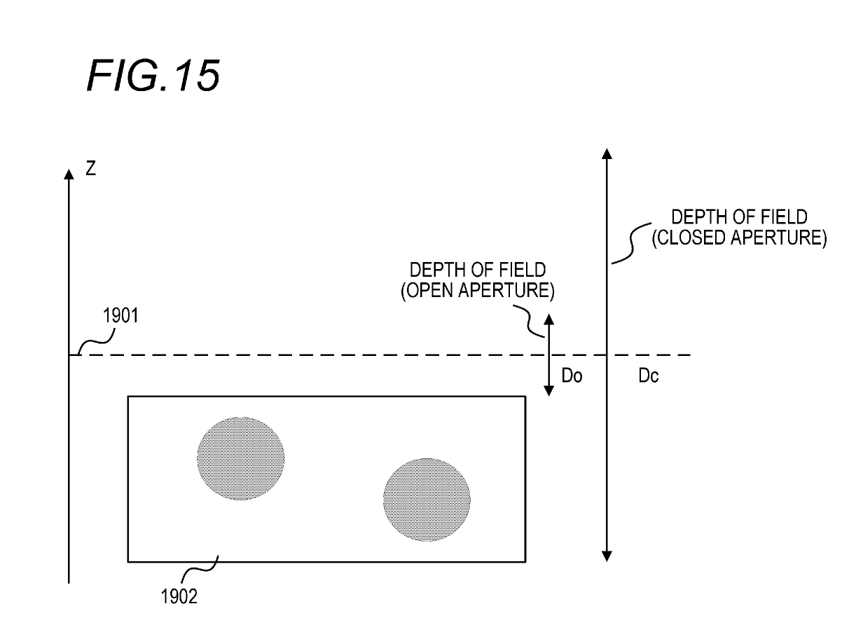

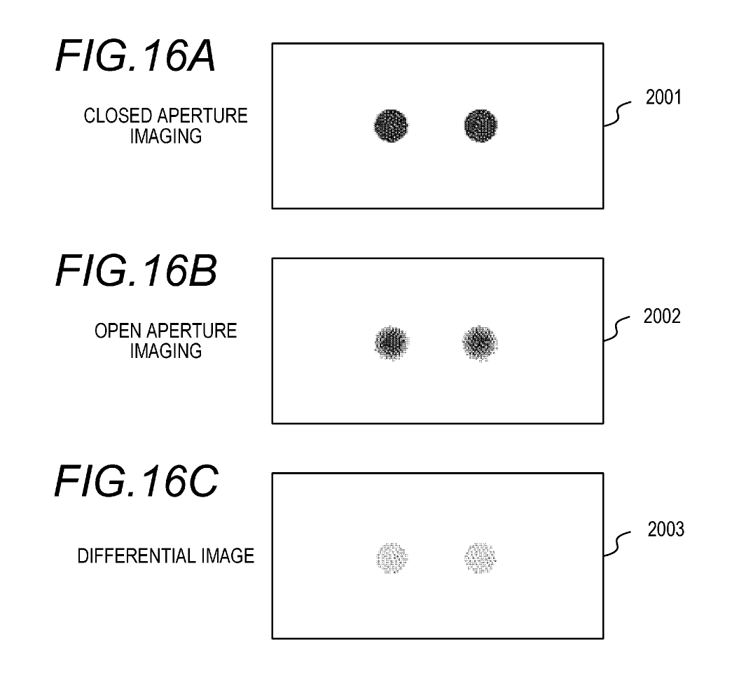

Referring to FIG. 15 and FIGS. 16A to 16C, differences between images acquired in the closed aperture imaging processing S1803 and the open aperture imaging processing S1804 will be described.

In FIG. 15, the reference numeral 1902 indicates a sample. The two circle portions in the sample 1902 schematically represent stained objects to be observed. A focal position 1901 is set at 1 μm above the sample 1902. The imaging optical system 305 has a tendency that the depth of field becomes greater when the aperture stop 306 is closed down, whereas the depth of field becomes smaller when the aperture stop 306 is opened. The depth of field Dc during closed aperture imaging is set to 5 μm, and the depth of field Do during open aperture imaging is set to 2.0 μm. The thickness of the sample 1902 is 4 μm. The thickness of the sample 1902 is measured with the use of the laser displacement meter 103 described in the first embodiment.

Since the depth of field Dc is greater than the thickness of the sample 1902 in the closed aperture imaging, an image focused to the entire thickness of the sample 1902 can be obtained. On the other hand, the depth of field Do is smaller than the thickness of the sample 1902 in the open aperture imaging. Therefore, in an image obtained by the open aperture imaging, the inside of the sample is blurry. (In general, the resolution is improved at a focusing position when the aperture stop is opened, but the variation is insignificant in comparison with the blurring due to the decreased depth of field, and hence the image quality evaluation index value is affected little.)

FIGS. 16A to 16C are schematic diagrams for qualitatively explaining a difference between images obtained by the closed aperture imaging and the open aperture imaging.

FIG. 16A illustrates an image 2001 acquired in the closed aperture imaging processing S1803, FIG. 16B illustrates an image 2002 obtained in the open aperture imaging processing S1804, and FIG. 16C illustrates a differential image 2003 between these two images 2001 and 2002.

Two circular portions shown in each image represent stained objects to be observed. In the image 2001, the entire sample is focused and a sharp image thereof can be obtained. In contrast, in the image 2002, the object image is blurry due to optical blurring. The differential image 2003 is obtained by the CPU 401 calculating an absolute value of difference between pixels of the image 2001 and the image 2002.

It can be said from the above that the difference between the two images captured with different aperture settings indirectly represents distribution of three-dimensional information contained in the sample 1902. Specifically, when the difference between the images is great, it can be estimated that the stained objects to be observed are present a lot outside of the depth of field in the open aperture imaging, and observation in the depth direction is required. When the difference between the images is small, in contrast, it can be estimated that the distribution of the stained objects to be observed in the depth direction is limited, and the necessity of observing in the depth direction is low. By controlling the number of images to be captured in the depth direction based on such estimation result in the main measurement, the number of captured images (data volume) can be reduced without causing lack of information required for the observation.

(Preliminary Measurement Estimation Control Processing: Imaging Condition Calculation Processing S903)

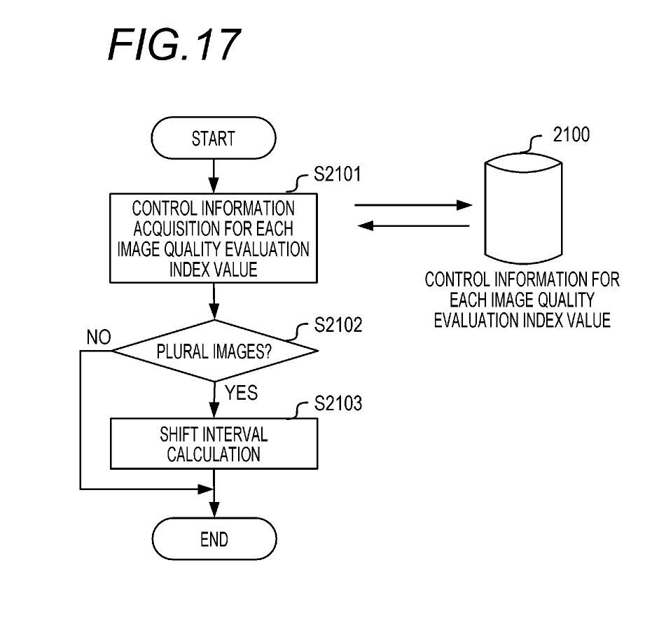

Internal processing of the imaging condition calculation processing S903 will be described with reference to FIG. 17.

In the imaging condition calculation processing S903, the host computer 110 calculates the Z stage control parameters in the following procedure.

In S2101, the host computer 110 acquires, from a data base 2100, control information corresponding to the image quality evaluation index value calculated in S902. This data base 2100 is installed in the external storage device 411 or another computer system 405. The control information thus obtained includes an image quality evaluation index value and the number of images to be captured corresponding thereto.

An example of the control information stored in the data base 2100 for each of the image quality evaluation index values is shown in the table below.

TABLE 1

| PSNR [dB] | Number of images to be captured |
|---|---|
| More than 45 | 1 |
| 40 to 45 | 3 |
| 35 to 40 | 5 |
| 30 to 35 | 7 |
| Less than 30 | 9 |

In this example, PSNR is used as the image quality evaluation index. PSNR is a measure which becomes greater as the difference between the two images becomes smaller. As is seen from the table above, there is a rule that the number of images to be captured is reduced when the difference between the images is small, and the number of images to be captured is increased when the difference is great.

For example, when the PSNR between two images obtained by the closed aperture imaging and the open aperture imaging is less than 30, the number of images to be captured is nine. When the PSNR is more than 45, the number of images to be captured is one.

An optimum value of the number of images to be captured for each of the image quality evaluation index values depends on imaging conditions including the difference in depth of field between the closed aperture imaging and the open aperture imaging of the preliminary measurement unit 102, and the aperture size (depth of field) of the main measurement unit 101. It is therefore desirable that the control information (the number of images to be captured) obtained for each of the imaging condition of the preliminary measurement unit 102 and the main measurement unit 101 is stored in the data base 2100. The host computer 110 may acquire the imaging conditions of the preliminary measurement unit 102 and the main measurement unit 101 and retrieve appropriate control information by way of the controller 108.

Subsequently, in S2102, the host computer 110 determines whether or not the number of images to be captured is greater than one based on the control information. When the number of images to be captured is one, the calculation of shift interval is not required and hence the processing is terminated. When the number of images to be captured is greater than one, the processing proceeds to S2103 in which the shift interval is calculated.

In S2103, the host computer 110 calculates the shift interval S [μm] with the following formula based on the sample thickness T [μm] and the number of images to be captured N. It is assumed in the present embodiment that the shift start position is the upper end. The sample thickness T is a value obtained by measurement with the laser displacement meter 103.

S=T/(N−1)

When the sample thickness is 4 μm, the PSNR is less than 30 and the number of images to be captured is nine, for example, the shift interval S is obtained to be 0.5 μm (=4/(9-1)).

Finally, in the imaging control processing S904, the imaging for the main measurement is performed with the use of the main measurement unit 101. Since this processing is the same as that of the first embodiment, the description thereof will be omitted.

### Modification of Second Embodiment

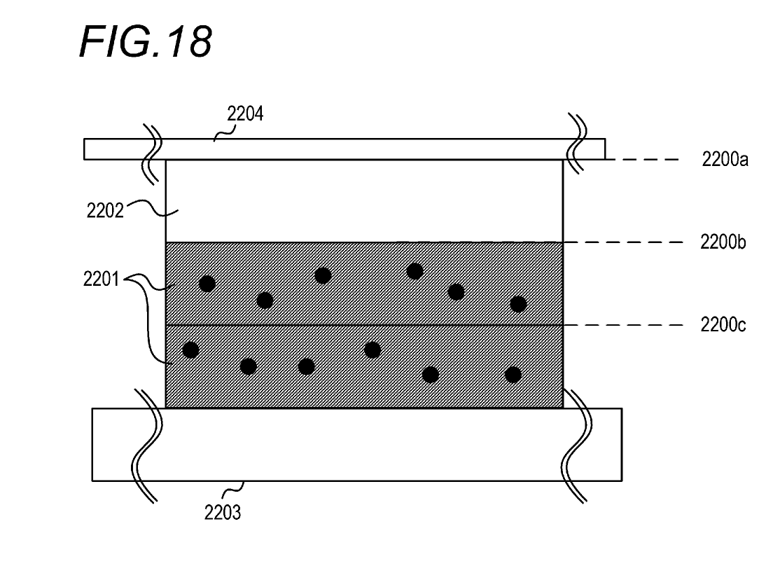

In the second embodiment, the number of images to be captured is obtained by considering the depth of the sample as one layer. However, when the sample is rather thick, the sample may be divided into a plurality of layers in the depth direction, and the number of images to be captured is obtained for each layer. This method makes it possible to optimize the number of images to be captured according to the feature of the sample in the depth direction, and thus further reduction of the data volume can be expected. This modification example is illustrated in FIG. 18.

A shaded area 2201 in FIG. 18 indicates a region of a pathological slice that is enclosed between a slide glass 2203 and a cover glass 2204. It is assumed that there is an area 2202 where no stained objects (portions indicated by the black circles) exist, between the shaded area 2201 and the cover glass 2204.

In the preliminary measurement, the sample (the distance between the lower end of the cover glass 2204 and the upper end of the slide glass 2203) is divided into layers with a predetermined thickness G [μm], and the aforementioned processing steps of S901 to S903 are performed for each layer. The thickness G can be determined based on the difference in depth of field between the closed aperture imaging and the open aperture imaging.

When the sample is divided into three layers, for example, as shown in FIG. 18, imaging is performed while changing the aperture size at three different focal positions 2200a, 2200b, and 2200c in a depth direction, and image quality evaluation index values I1, I2, and I3 are obtained for the respective images.

At the focal position 2200a, there is no stained object within the depth of field, and therefore the difference between the images of the closed aperture imaging and the open aperture imaging is small. In contrast, at the focal positions 2200b and 2200c, there exist stained objects near the focal positions, and thus the difference between the images of the closed aperture imaging and the open aperture imaging is large. For example, when the PSNR is used as the image quality evaluation index, the image quality evaluation index values I2 and I3 become smaller than the value I1.

The host computer 110 uses the image quality evaluation index values I1, I2, and I3 to acquire control information for the respective layers from the data base 2100, and determines the numbers of images to be captured N1, N2, and N3 for the respective layers. Then, the shift intervals S1, S2, and S3 for the respective layers are obtained with the following formula:

Si=G/(Ni−1)(i=1, 2, . . . ).

According to the method of the second embodiment described above, the number of images to be captured can be obtained by evaluating the blur amount generated when the aperture stop is changed in the preliminary measurement and thereby estimating the distribution of three-dimensional objects existing in the inside of the sample. This makes it possible to optimize the number of images to be captured, minimize the data volume, and improve the throughput. When observation in a depth direction is required, a plurality of images are captured, whereby lack of information required for the observation can be prevented.

It can be envisaged that difference in color strength or staining between the samples may affect the difference between the images. In such a case, the estimation of the stain method according to the first embodiment can be combined with the method of the second embodiment, so that the accuracy is enhanced by referring to control information for each of the image quality evaluation index values classified using the stain methods as indices.

In the present embodiment, a focused image is generated by narrowing the aperture stop in the closed aperture imaging processing. Instead, for example, a deep-focus image may be generated by acquiring video images (a plurality of images with different focal positions) which are sequentially captured while changing the focal position, and combining the plurality of images. This processing is called focus stacking. In this case, information in the depth direction is estimated in the same manner as the second embodiment, by evaluating the difference between the deep-focus image and each of the images of the plurality of images from which the deep-focus image is generated, whereby the required number of images to be captured can be determined.

Although the description of the present embodiment has been made on the assumption that monochrome (gray scale) images are used, a similar evaluation of image quality is possible also for color images. It should be understood that imaging of color images is also covered by this invention.

Although, in the description of the present embodiment, PSNR and SSIM are mentioned as examples of the image quality evaluation indices, various other image quality evaluation indices such as difference standard deviation and normalized cross-correlation are also applicable. The image quality evaluation may be performed in consideration of not only the values of the entire images but also the maximum value of the differences. This makes it possible to acquire images without missing any significant change occurring locally.

Although, in the present embodiment, three-dimensional distribution of objects within the sample is estimated for the slide as a whole, the three-dimensional distribution of the objects within the sample may be estimated for each of the imaging regions obtained by segmenting the slide as shown in FIG. 5B. In this case, the size of the segmented sections may be determined arbitrarily.

### Third Embodiment

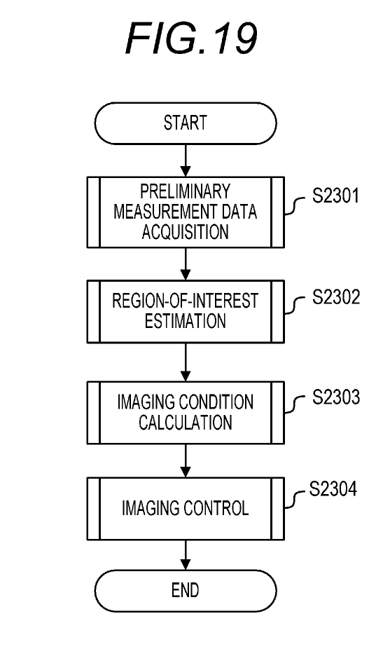

As shown in FIG. 19, a third embodiment is characterized in that the depth information estimation processing S902 (see FIG. 4B) in the flow of the preliminary measurement estimation control processing is replaced with region-of-interest estimation processing S2302. In the region-of-interest estimation processing S2302, image data obtained in the preliminary measurement is analyzed to find a feature thereof and to estimate a region of interest of the user. In imaging condition calculation processing S2303, the Z stage control parameters are calculated based on the estimation result of the estimation of the region of interest.

Detailed description will be made of the processing steps from the region-of-interest estimation processing S2302 to imaging control processing S2304. Since the content of the preliminary measurement data acquisition processing S2301 is the same as in the first embodiment, the description thereof will be omitted.

(Preliminary Measurement Estimation Control Processing: Region-Of-Interest Estimation Processing S2302)

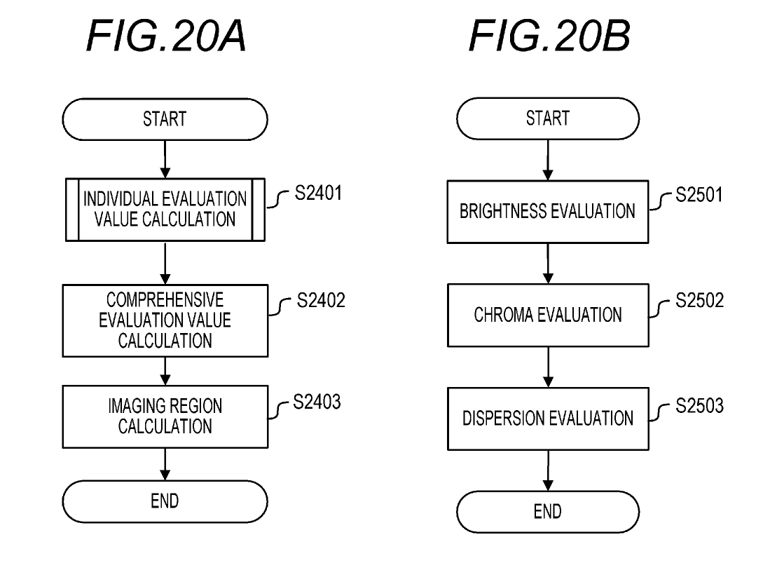

As shown in FIG. 20A, the estimation of region of interest consists of three steps of the individual evaluation value calculation processing S2401, comprehensive evaluation value calculation processing S2402, and imaging region calculation processing S2403. In S2401, evaluation is performed on a plurality of indices, and a region of interest in the preliminary measurement data is estimated for each of the indices. The evaluation indices include image brightness, dispersion, chroma and so on. An evaluation map of the same size as the preliminary measurement data is output for each of the evaluation indices. In S2402, a comprehensive evaluation map is generated by integrating while weighting the evaluation maps for the respective evaluation indices. Finally, in S2403, an effective region worthy of imaging is determined by using the comprehensive evaluation map.

Details of the respective steps will be described.

(1) Individual Evaluation Value Calculation Processing S2401

A biological microscope observes light applied from below the slide (i.e. transmitted light), based on difference in color. Therefore, there is a certain correlation between thickness of the sample and reduction in brightness of an image to be observed. In addition, high chroma (a prominent particular color) implies a high correlation with the fact that cells which are originally substantially transparent are stained for observation. High dispersion implies high possibility that the relevant pixels are varied in comparison with the surrounding area thereof, that is, the pixels are the object to be observed. Therefore, the evaluation values thereof indicate implicitly that detailed observation is required. The probability of being the object to be observed is increased by overlapping of such implicit conditions.

FIG. 20B illustrates an internal processing of the individual evaluation value calculation processing S2401.

Firstly, brightness evaluation processing S2501 will be described. The host computer 110 obtains a brightness value Y for each pixel of the preliminary measurement data. For example, the preliminary measurement data is converted into sRGB by color conversion processing, and then brightness value Y is obtained with the formula below:

Y=0.299R+0.587G+0.114B.

Subsequently the host computer 110 obtains a brightness evaluation value V1 for each pixel based on the brightness value Y. The brightness evaluation value V1 is set so as to become greater as the brightness value Y becomes smaller (as the brightness becomes lower). For example, in the present embodiment, the brightness evaluation value V1 is obtained with the following formula:

V1=((Ymax−Y)/Ymax)×L1

where Ymax denotes a maximum brightness value Y, L1 denotes a parameter for adjusting the range of the brightness evaluation value V1. In the present embodiment, L1 is set to 10, and the brightness evaluation value V1 assumes a value within a range from 0 to 10.

In the brightness evaluation processing S2501, the brightness evaluation value V1 is calculated for all the pixels of the preliminary measurement data, whereby a brightness evaluation image EV1 is generated.

Next, chroma evaluation processing S2502 will be described.

The host computer 110 color-space converts the preliminary measurement data into a CIE L*a*b* color space. This processing is realized by converting an sRGB color space into an XYZ color space, and then converting the XYZ color space into a CIE L*a*b* color space. In the CIE L*a*b* color space, L* denotes a brightness component, and a* and b* represent color components. Clearness of color, that is, a chroma C can be obtained as a distance from the origin of the color component (a*, b*).

The host computer 110 then obtains a chroma evaluation value V2 for each pixel based on the chroma C. The chroma evaluation value V1 is set so as to become greater as the chroma C becomes greater (the chroma becomes higher). For example, in the present embodiment, the chroma evaluation value V2 is obtained with the following formula:

V2=(C/Cmax)×L2

where Cmax denotes a maximum value of chroma (the chroma of a color spot with the highest color purity among those having the same hue), and L2 is a parameter for adjusting the range of the chroma evaluation value V2. In the present embodiment, L2 is set to 10, and the chroma evaluation value V2 assumes a value within a range from 0 to 10.

The chroma evaluation value V2 may be obtained while weighing a specific hue. When a color which frequently appears due to staining, for example, when a color blue which appears when a nucleus is stained with hematoxylin, the setting may be such that the evaluation value V2 becomes greater.

In the chroma evaluation processing S2502, the chroma evaluation value V2 is calculated for all the pixels of the preliminary measurement data, and a chroma evaluation image EV2 is generated.

Next, dispersion evaluation processing S2503 will be described.

The host computer 110 calculates a dispersion value for each channel of the RGB, and obtains a dispersion evaluation value V3 for each pixel by summing the calculated dispersion values. In the third embodiment, the dispersion evaluation value V3 is also normalized to assume a value from 0 to 10, like the other evaluation values V1 and V2.

A dispersion calculation method for the pixels will be described. Firstly, an average is calculated in a rectangle of a certain size (e.g. 9×9 pixels) centered around a pixel to be processed. A dispersion within the rectangle is then obtained using the average. This processing is performed for each channel.

In the dispersion evaluation processing S2503, the dispersion evaluation value V3 is calculated for all the pixels of the preliminary measurement data, and a dispersion evaluation image EV3 is generated.

(2) Comprehensive Evaluation Value Calculation Processing S2402

The comprehensive evaluation value calculation processing in S2402 will be described in detail.

As described above, in the processing of S2401, a brightness evaluation image EV1, a chroma evaluation image EV2, and dispersion evaluation image EV3 having the same size as the preliminary measurement data are generated. In S2402, a comprehensive evaluation image is generating by comprehensively evaluating these values. When the comprehensive evaluation image is denoted by TEV, it can be represented as the following formula:

TEV=f(EV1,EV2,EV3).

While various modifications can be envisaged for the function f, it will be considered, in the present embodiment, in the form represented by the formula:

TEV=EV1+EV2+EV3.

In this comprehensive evaluation image TEV, the values of the respective pixels (referred to as comprehensive evaluation values) each assume a value from 0 to 30, and the value becomes greater at a point with low brightness, high chroma, and high dispersion. This means that a pixel with a great comprehensive evaluation value approximately indicates a region of interest.

The method of obtaining a comprehensive evaluation image is not limited to the method described above. For example, it can be obtained with the formula:

TEV=αEV1+βEV2+γEV3

by using weighting coefficients α, β, and γ.

In addition to summing, various individual evaluation functions and comprehensive evaluation functions can be set as long as a point with low brightness, high chroma, and high dispersion can be specified as the region of interest.

For example, the comprehensive evaluation image TEV may be represented by a multiplication expression as described below.

TEV=K(EV1)α×(EV2)β×(EV3)γ

where α, β, γ, and K are constants.

(3) Imaging Region Calculation Processing S2403

Finally, in the imaging region calculation processing S2403, the host computer 110 determines an imaging target region using the comprehensive evaluation value. In this example, pixels having a comprehensive evaluation value equal to or greater than a predetermined threshold (e.g. 5 or more) are extracted, and a circumscribed rectangle of a group of the extracted pixels is determined to be the imaging target region, while the other region is exempted from the imaging target.

(Preliminary Measurement Estimation Control Processing: Imaging Condition Calculation Processing S903)

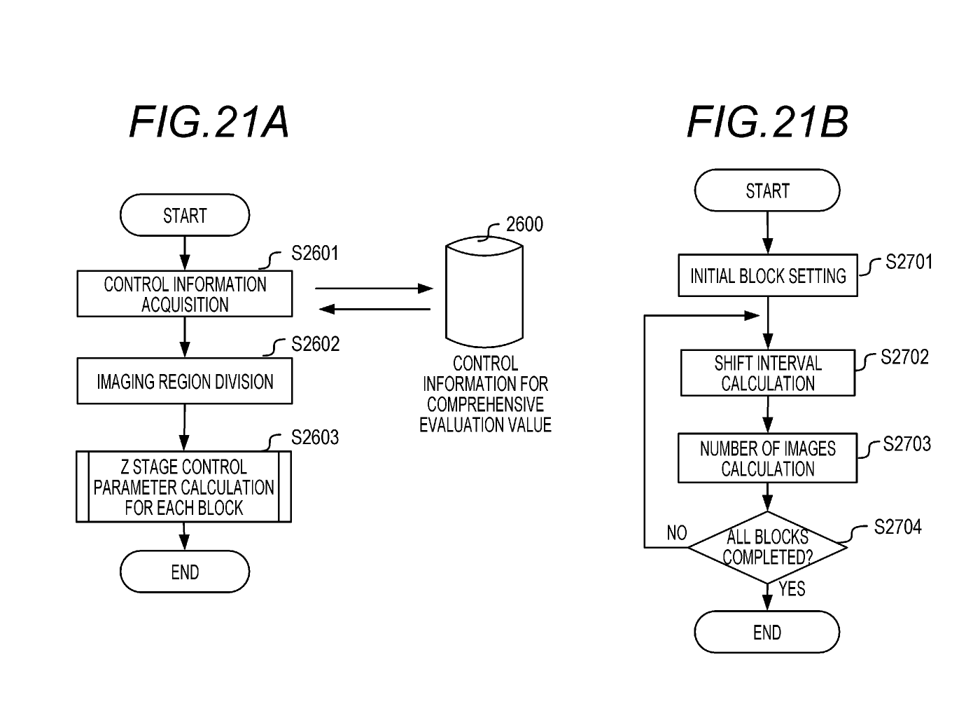

Internal processing of the imaging condition calculation processing S2303 will be described with reference to FIGS. 21A and 21B.

In step S2601, the host computer 110 acquires from a data base 2600 control information and a region division size corresponding to the comprehensive evaluation value calculated in S902. This data base 2600 is stored in the external storage device 411 or another computer system 405.

The control information contains description of (comprehensive evaluation value range, shift interval) using the comprehensive evaluation value range as an index.

The region division size indicates a size of region division performed in the next step S2602.

If the comprehensive evaluation value is high, the shift interval is set small since the relevant region is likely to be a region of interest. If the comprehensive evaluation value is low, in contrast, the shift interval is set large since the relevant region is unlikely to be a region of interest. For example, there is a relationship between comprehensive evaluation value and shift interval as shown in the table below.

TABLE 2

| Comprehensive evaluation value | Shift interval |
|---|---|
| 20 to 30 | Same as depth of field D |
| 10 to 20 | Twice depth of field D |
| 5 to 10 | Three times depth of field D |

In the table above, D indicates a depth of field of the main measurement unit 101. The depth of field D varies depending on imaging conditions such as the state of the imaging optical system 205 or the aperture stop 206. Therefore, it is desirable to calculate the depth of field D for each of the imaging conditions such as focal position and aperture stop to prepare a database of depth of field, so that the host computer 110 can retrieve a value of depth of field D from the data base as necessary.

In step S2602, the host computer 110 segments the imaging target region determined in S2403 into a plurality of blocks using the region division size acquired in S2601. In the present embodiment, the region division size is set to a size corresponding to the area 601 shown in FIG. 5B. The imaging target region may be segmented into blocks of a smaller size than the area 601 shown in FIG. 5B. This will enable fine control for each block, whereas the number of times of imaging in total is increased.

In step S2603, the host computer 110 calculates Z stage control parameters for each block using the control information. FIG. 21B illustrates particulars of the step S2603.

In step S2701, the host computer 110 sets a block to be processed first (for example, the upper left block in the imaging target region) as an initial block in order to start repeated processing for the blocks.

In step S2702, the host computer 110 obtains a shift interval based on the control information. Specifically, the host computer 110 selects a maximum comprehensive evaluation value in a block as a comprehensive evaluation value of the block, and selects a shift interval corresponding to the comprehensive evaluation value from the control information.

For example, the shift interval is set to the value of the depth of field D multiplied by two for a block whose comprehensive evaluation value is 15. When the depth of field D of the main measurement unit 101 is 0.5 μm, the shift interval is set to 1.0 μm.

In step S2703, the host computer 110 determines the number of images to be captured based on a sample thickness and the shift interval calculated in S2702. It is assumed here that the sample thickness has been measured with the laser displacement meter 103 or the like as described in the first embodiment. Description of the present embodiment will be made on the assumption that the shift start position is always at the lower end of the sample thickness, that is, at the surface of the slide glass.

When it is assumed here that the measured sample thickness is T [μm], and the shift interval is Si [μm], the number of images to be captured Ni in a block i (i=1, 2, . . . ) can be represented as:

Ni=1 when T<Si, and

Ni=CEIL(T/Si)+1 when T≧Si.

(Preliminary Measurement Estimation Control Processing: Imaging Control Processing S904)

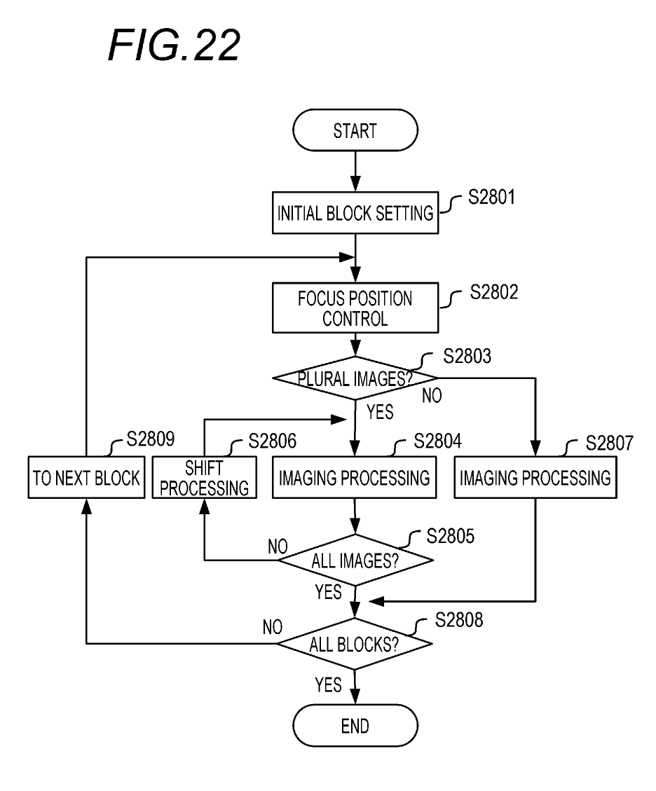

Details of imaging control processing S2304 will be described with reference to FIG. 22.

Firstly, the controller 108 sets an initial block to be imaged on the main measurement unit 101. In the present embodiment, the block at the upper left in the imaging target region is selected as the first block to be imaged.

Subsequently, in step S2802, the controller 108 sets a focus position of the main measurement unit 101. Since the shift start position is set at the lower end, the focal position is set at the surface of the slide glass.

In step S2803, the controller 108 determines whether or not the number of images to be captured in the block to be processed i is greater than one. If the number is one, the processing proceeds to step S2807 to perform imaging processing, and then proceeds to step S2808. When a plurality of images are to be captured, the processing proceeds to step S2804 in which imaging processing is performed according to the shift interval and the number of images for each block, and then proceeds to step S2805. In S2805, it is determined whether or not the imaging of the number of images set for each block has been completed. If completed, the processing proceeds to step S2808, whereas if not completed, the focal position is shifted in a depth direction in S2806, and imaging processing is performed in S2804.

In S2808, the controller 108 determines whether or not imaging of all the blocks has been completed. If not completed, the processing proceeds to step S2809 and moves to the next block. The processing is terminated once imaging of all the blocks is completed.

According to the third embodiment described above, image features are analyzed in the preliminary measurement to estimate a region of interest, whereby a shift interval required for imaging the region of interest is determined. This provides the advantageous effects of optimizing the number of images to be captured, reducing the file capacity required for imaging, and improving the throughput both in data transmission and storage. Further, since a plurality of images are captured for a region of interest requiring observation in a depth direction, the lack of information required for observation can be prevented.

It is envisaged that difference in color strength or difference in color due to staining of samples may affect the difference between images. In that case, the accuracy can be increased by combining the estimation of the stain method according to the first embodiment and referring to the control information for each of the comprehensive evaluation values classified by using the stain methods as indices.

Like the second embodiment, in the third embodiment as well, as shown in FIG. 18, the preliminary measurement is performed while changing the focal position in the depth direction, and the number of images to be captured near each focal position can be determined according to a comprehensive evaluation value. Since the number of objects to be observed can be estimated to be small when the comprehensive evaluation value is low, the number of images to be captured near there can be reduced.

Although, in the third embodiment, three types of evaluation values of brightness, chroma, and dispersion are used, the region of interest may be estimated by using one or two of these evaluation values. It is also possible to combine other evaluation values.

### Other Embodiments

The aforementioned embodiments are just representative examples, and various other modifications and variations are possible for embodying the invention.

For example, in the embodiments above, two separate imaging units are used, consisting of the main measurement unit 101 (first imaging unit) and the preliminary measurement unit 102 (second imaging unit) for performing imaging with a lower magnification than the main measurement unit 101. This separate-unit configuration has advantages that the need of a lens drive system is eliminated by using separate imaging units for different magnifications, the hardware structure of the imaging optical system can thus be simplified, and the throughput can also be improved since the preliminary measurement and the main measurement are performed in parallel. However, the preliminary measurement and the main measurement can be performed by using a single imaging unit. The single-unit configuration has an advantage that the size of the apparatus can be reduced. In the case of the single-unit configuration, the preliminary measurement may be performed by the imaging optical system with the magnification set low. Alternatively, image data captured at a fixed magnification (at the same magnification between the preliminary measurement and the main measurement) is subjected to thinning processing to reduce the resolution, so that it is used for determination of the number of images to be captured.

Although the description of the embodiments above has been made on the assumption that imaging is performed on the region where the cover glass exists, the imaging may be performed only on the region where the sample exists to reduce the data volume. In that case, a circumscribed rectangle of the region where the sample exists is obtained first, and the imaging is performed only on this region as the imaging target region. The method of determining the imaging target region by obtaining a circumscribed rectangle of a region with low brightness is well known in related art.

The description of the embodiments above has been made on the assumption of the case in which control information for each stain method, control information for each image quality evaluation index value, and control information for each comprehensive evaluation value are preliminarily prepared. However, it is also possible to establish new rules by utilizing an image obtained by preliminary measurement of each slide during manual operation of the virtual slide system, and imaging conditions set by the user. For example, new rules can be established by using a machine learning technique for analysis of a large amount of data to extract useful rules and determination criteria.

Although the description of the embodiments above has been made in terms of a case in which the preliminary measurement unit captures a color image having three colors of RGB or a monochrome image, the same processing can be performed with the use of spectral image data. The use of spectral image data enables analysis of features of a sample in units of spectra.

In addition, color image data of three colors of RGB can be easily obtained from spectral image data by calculation of the spectral data of the sample and a 2 degree color matching function representing sensitivity characteristic of human eyes. Therefore, a preliminary measurement unit having a spectrometric measurement function can also be used.

In the description of the embodiments above, color imaging with the main measurement apparatus and preliminary measurement apparatus is implemented by the method of acquiring a color image by exposing the image three times with three different light sources of RGB. However, the color imaging is possible with other methods.

For example, when an imaging element in which RGB three-color filters are Bayer-arrayed is used, a RGB color image can be obtained by performing demosaicing processing in the development/merging processing S1004. Further, imaging may be performed by arranging a color separation element such as a dichroic prism in the imaging optical system 305 to separate the image color into RGB and imaging the color-separated image with the use of three imaging elements. In that case, a RGB color image can be obtained by combining the images color-separated into RGB in the image development processing.

Further, although the description of the embodiments above has been made in terms of a virtual slide system having the host computer 110 and the virtual slide scanner 120 as shown in FIG. 1. However, the configuration of the apparatus is not limited to this as long as the invention can be implemented by a system as a whole. For example, the host computer 110 and the virtual slide scanner 120 may be an integral apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-033116, filed on Feb. 18, 2011, which is hereby incorporated by reference herein in its entirety.

What is claimed is:

1. An imaging apparatus comprising:
a stage on which an object is placed;
an imaging unit having an imaging device, and an imaging optical system for magnifying an image of the object on the stage and guiding the magnified image to the imaging device;
a control unit for controlling the stage and the imaging unit; and
an image processing unit for processing image data obtained by the imaging unit,
wherein:
the image processing unit determines the number of images to be captured of the object by analyzing image data obtained by imaging the object on the stage;
the control unit performs, according to the number of images to be captured determined by the image processing unit, either first processing for acquiring image data of a single image by imaging the object on the stage, or second processing for acquiring image data of a plurality of images with different focal positions by imaging the object on the stage for a plurality of times while changing the focal position.

2. The imaging apparatus according to claim 1, wherein:
the imaging unit has a first imaging unit and a second imaging unit for performing imaging at a lower magnification than the first imaging unit;
the image processing unit determines the number of images to be captured of the object by using the image data obtained by the second imaging unit; and
the control unit controls the first imaging unit to perform either the first processing or the second processing.

3. The imaging apparatus according to claim 1, wherein the image processing unit estimates a stain method of the object by analyzing the image data, and determines the number of images to be captured of the object according to the estimated stain method.

4. The imaging apparatus according to claim 1, wherein the image processing unit analyzes a plurality of pieces of image data of the same object with different depths of field to thereby evaluate a difference between the images of the object due to the difference in depth of field, and determines the number of images to be captured of the object such that the number is greater as the evaluated difference is greater.

5. The imaging apparatus according to claim 4, wherein the image processing unit divides the object into a plurality of layers in an optical axis direction, and evaluates for each layer a difference between images due to difference in depth of field to thereby determine the number of images to be captured for each layer.

6. The imaging apparatus according to claim 4, wherein:
the imaging unit has an aperture stop; and
the plurality of pieces of image data with different depths of field are data obtained by imaging the same object while changing an aperture size of the aperture stop.

7. The imaging apparatus according to claim 4, wherein, among the plurality of pieces of image data with different depths of field, the image data with a large depth of field is data obtained by combining a plurality of pieces of image data obtained by imaging the same object at different focal positions.

8. The imaging apparatus according to claim 1, wherein the image processing unit evaluates brightness of the image data, and determines the number of images to be captured of the object such that the number is greater as the brightness is lower.

9. The imaging apparatus according to claim 1, wherein the image processing unit evaluates chroma of the image data, and determines the number of images to be captured of the object such that the number is greater as the chroma is higher.

10. The imaging apparatus according to claim 1, wherein the image processing unit evaluates dispersion of the image data, and determines the number of images to be captured of the object such that the number is greater as the dispersion is higher.

11. The imaging apparatus according to claim 1, wherein the image processing unit divides the image data into a plurality of blocks, and determines the number of images to be captured for each block.

12. The imaging apparatus according to claim 1, further comprising:
a data base for storing control information containing information obtained by analyzing the image data and the number of images to be captured corresponding to this information,
wherein the image processing unit determines the number of images to be captured by referring to the control information.

13. The imaging apparatus according to claim 1, further comprising:
a data base for storing control information containing information obtained by analyzing the image data and a shift interval of a focal position corresponding to this information,
wherein the image processing unit determines the number of images to be captured based on a thickness of the object and the shift interval in the control information.

14. An imaging method for use in an imaging apparatus including a stage on which an object is placed, and an imaging unit having an imaging device, and an imaging optical system for magnifying an image of the object on the stage and guiding the magnified image to the imaging device, the method comprising:
a preliminary measurement step of imaging an object on the stage with the imaging unit;
a determination step of determining the number of images to be captured of the object by analyzing the image data obtained in the preliminary measurement step; and
a main measurement step of performing, according to the number of images to be captured determined in the determination step, either first processing for acquiring image data of a single image by imaging the object on the stage, or second processing for acquiring image data of a plurality of images with different focal positions by imaging the object on the stage for a plurality of times while changing the focal position.
